(19) United States
(12) Patent Application Publication
(10) Pub. No.: US 2025/0163339 A1
(43) Pub. Date: May 22, 2025

(54) PELLETIZED PRODUCTS AND ASSOCIATED SYSTEMS, DEVICES, AND METHODS

(71) Applicant: SUNCOKE TECHNOLOGY AND DEVELOPMENT LLC, Lisle, IL (US)

(72) Inventors: John Francis Quanci, Haddonfield, NJ (US); John Michael Richardson, Devon, PA (US); Jonathan Hale Perkins, Lisle, IL (US)

(21) Appl. No.: 18/949,426

(22) Filed: Nov. 15, 2024

Related U.S. Application Data
(60) Provisional application No. 63/599,997, filed on Nov. 16, 2023.
(60) Provisional application No. 63/648,626, filed on May 16, 2024.

(51) Int. Cl. C10L 5/36; C10L 5/14; C10L 5/22; C10L 5/44; C10L 9/02; C10L 9/08; C10L 9/10

(52) U.S. Cl. CPC C10L 5/363; C10L 5/14; C10L 5/22; C10L 5/447; C10L 9/02; C10L 9/08; C10L 9/10; C10L 2290/02; C10L 2290/24; C10L 2290/28; C10L 2290/30

(57) ABSTRACT

Production systems and methods for producing pellets or pellet products, which can be used, e.g., in an electric arc furnace (EAF) to produce metal alloys, are disclosed herein. In some embodiments, a method for forming coke pellets includes (i) blending biomass with a set of materials to form an input blend, (ii) preconditioning the input blend by hydrating the input blend to generate a first plurality of particles, (iii) charging the first plurality of particles into an oven to produce a second plurality of particles via pyrolysis, (iv) post-conditioning the second plurality of particles to produce a third plurality of particles by exposing the second plurality of particles to at least one of an amphipathic binder, a hydrophobic binder, or a hydrophilic binder, and (v) physically altering the third plurality of particles to form coke pellets. The biomass can have a first volatility and the set of materials can have a second volatility lower than the first volatility.

### CROSS-REFERENCE TO RELATED APPLICATIONS

The present application claims the benefit of U.S. Provisional Patent Application No. 63/599,997, filed Nov. 16, 2023, and U.S. Provisional Patent Application No. 63/648,626, filed May 16, 2024, the disclosures of which are incorporated herein by reference in their entireties. The present application is also related to (i) U.S. patent application Ser. No. 18/501,795, filed Nov. 3, 2023, titled “COAL BLENDS, FOUNDRY COKE PRODUCTS, AND ASSOCIATED SYSTEMS, DEVICES, AND METHODS,” (ii) U.S. patent application Ser. No. 18/052,760, filed Nov. 4, 2022, titled “FOUNDRY COKE PRODUCTS, AND ASSOCIATED SYSTEMS, DEVICES, AND METHODS,” (iii) U.S. patent application Ser. No. 18/511,148, filed Nov. 16, 2023, titled “PRODUCTS COMPRISING CHAR AND CARBON, AND ASSOCIATED SYSTEMS, DEVICES, AND METHODS,” and (iv) U.S. patent application Ser. No. 18/511,621, filed Nov. 16, 2023, titled “PELLETIZED PRODUCTS AND ASSOCIATED SYSTEMS, DEVICES, AND METHODS,” the disclosures of which are incorporated herein by reference in their entireties.

### TECHNICAL FIELD

The present technology is generally directed to production methods and systems for producing a product including a population of pellets.

### BACKGROUND

Heat processing of a carbonaceous material under a controlled condition (e.g., at a raised temperature in an oxygen-limited or oxygen-deprived environment) can remove or reduce volatile matter (VM) and produce a product with an increased content of the element carbon. For example, coal can be treated in a process known as the “Thompson Coking Process” to be devolatilized and produce a fused mass of coke having a predetermined porosity and strength.

### BRIEF DESCRIPTION OF THE DRAWINGS

Non-limiting and non-exhaustive embodiments of the present invention, including the preferred embodiment, are described with reference to the following figures, wherein like reference numerals refer to like parts throughout the various views unless otherwise specified.

FIG. 1 depicts a partial cutaway view of a portion of a heat plant, in accordance with embodiments of the present technology.

FIG. 2 depicts a sectional view of an oven, configured in accordance with embodiments of the present technology.

FIG. 3 depicts a feedstock blend, in accordance with embodiments of the present technology.

FIG. 4 is a flowchart of a method for determining a blend composition, in accordance with embodiments of the present technology.

FIG. 5 is a flowchart of a method for performing blend pre-processing for a feedstock before charging the feedstock into an oven, in accordance with embodiments of the present technology.

FIG. 6 is a flowchart of a method to produce output particulates using a production system, in accordance with embodiments of the present technology.

FIG. 7 depicts a schematic of a production system in accordance with embodiments of the present technology.

FIG. 8 depicts pellets in accordance with embodiments of the present technology.

FIG. 9 is a flowchart illustrating a method for forming coke pellets in accordance with embodiments of the present technology.

FIG. 10 is a flowchart illustrating another method for forming coke pellets in accordance with embodiments of the present technology.

A person skilled in the relevant art will understand that the features shown in the drawings are for purposes of illustration, and variations, including different or additional features and arrangements thereof, are possible.

### DETAILED DESCRIPTION

### I. Overview

The present technology is generally directed to production systems and methods for producing pellets or pellet products, which can be used, e.g., in an electric arc furnace (EAF) to produce metal alloys. Coal is processed in coke facilities to produce coke products of varying size, including foundry of 4+ inches (in.), egg of approximately 2×4 in., stove of 1×2 in., and coke particulates of less than 1 in. or ¾ in. While the foundry and egg can be sold as product, the coke particulate is generally too fine to be sold as a product. The industry has not been successful in finding a method of consuming and/or disposing of this material, and thus a major portion of the coke particulate generated is landfilled.

Embodiments of the present technology attempt to mitigate this issue associated with wasting coke particulates (“coke breeze” or “breeze”) and other traditional waste materials by pelletizing these particulates to produce a pellet product with underlying value for multiple industries. As described herein, some embodiments of the present technology can include an oven (e.g., a coke oven, a devolatilization oven, a pyrolysis oven, a blast furnace) configured to receive and heat an input material (e.g., coal) at a processing temperature of at least 1,000° F. to produce processed materials, which can include coke products (e.g., foundry) and particulates (e.g., breeze). In some embodiments, the processed materials include pyrolysis products. The particulates can be pelletized to produce a population of pellets that include the component of interest. In some embodiments, the particulates can be mixed with other particulate material(s) from a different source (e.g., iron fines, anthracite fines, coal fines, metal fines, blast furnace dust, baghouse fines, waste materials, crushed foundry coke breeze, petroleum coke breeze, anthracite fines, and/or calcined anthracite fines), and the mixed particulate materials can be pelletized into products having a size of at least 1/25 in., 1/23 in., 1/20 in., 1/16 in., 1/10 in., ⅛ in., ⅕ in., ¼ in., ⅓ in., ½ in., ¾ in., 1 in., etc. In some embodiments, before pelletization, the particulate materials can be tuned such that the produced pellets have a desired property (e.g., density, chemical composition, size, strength, degradation profile, moisture content, etc.) specified by a downstream user and/or determined according to an intended use of the produced pellets.

Specific details of several embodiments of the technology are described below. Other details describing well-known structures and systems often associated with combustion facilities, pelletization facilities, or automated control systems have not been set forth in the following disclosure to avoid unnecessarily obscuring the description of the various embodiments of the technology. Many of the details, dimensions, angles, and other features shown in the figures are merely illustrative of particular embodiments of the technology. Accordingly, other embodiments can have other details, dimensions, angles, and features without departing from the spirit and/or scope of the present technology. A person of ordinary skill in the art, therefore, will accordingly understand that the technology can have other embodiments with additional elements, or the technology can have other embodiments without several of the features shown and described below.

### II. Overview of Systems and Methods for Producing Pelletized Products

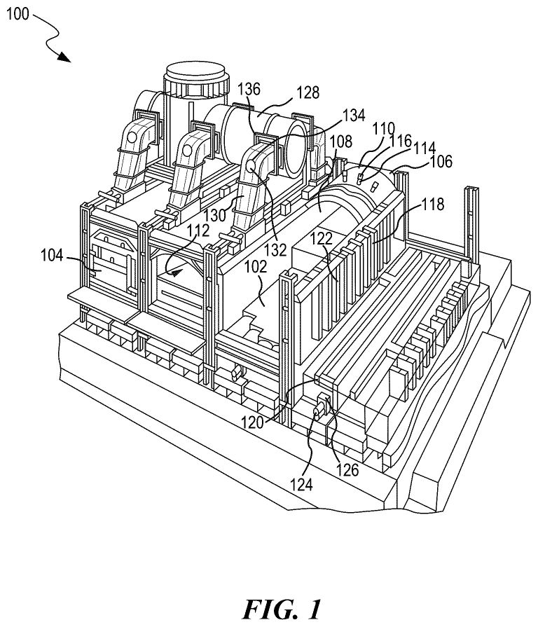

FIG. 1 cutaway view of a portion of an oven 100, in accordance with embodiments of the present technology. It is understood that the oven 100 is provided here merely for illustration purposes and is not intended to limit the scope of the present disclosure. In some embodiments, the oven 100 can be a non-heat recovery oven (e.g., a byproduct oven). In some embodiments, the oven 100 can be a different type of combustion oven than an HHR oven. In some embodiments, the oven 100 can be a heat processing oven including, e.g., a devolatilization oven, a pyrolysis oven, or a blast furnace.

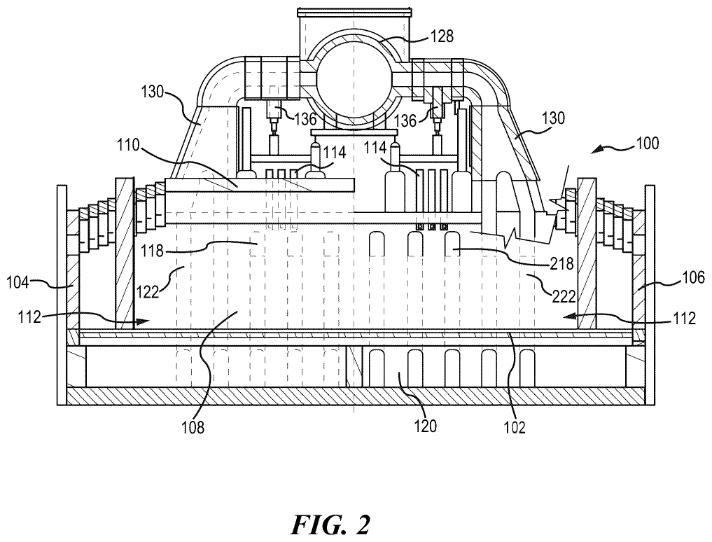

The oven 100 includes an open cavity defined by an oven floor 102, a pusher side oven door 104, an output side oven door 106 opposite the pusher side oven door 104, opposite sidewalls 108 that extend upwardly from the oven floor 102 and between the pusher side oven door 104 and output side oven door 106, and a crown 110 (e.g., a radiant oven crown), which forms a top surface of the open cavity of an oven chamber 112. Controlling airflow and pressure inside the oven chamber 112 plays a significant role in the efficient operation of the heat processing cycle. Embodiments of the present technology include a set of crown air inlets 114 that allow primary combustion air into the oven chamber 112. In some embodiments, multiple inlets of the set of crown air inlets 114 penetrate the crown 110 in a manner that selectively places oven chamber 112 in open fluid communication with the ambient environment outside the oven 100. The oven 100 can include an uptake elbow air inlet (not shown in FIG. 1 or 2) having an air damper of the air dampers 116, which can be positioned at any of a number of positions between fully open and fully closed to vary an amount of airflow through the air inlet. Other oven air inlets, including door air inlets and the set of crown air inlets 114, include air dampers 116 that operate in a similar manner. The uptake elbow air inlet can be positioned to allow air into the common tunnel 128, whereas the door air inlets and the set of crown air inlets 114 vary an amount of airflow into the oven chamber 112. While embodiments of the present technology can use crown air inlets 114, exclusively, to provide primary combustion air into the oven chamber 112, other types of air inlets, such as the door air inlets, can be used in particular embodiments without departing from aspects of the present technology.

Various air inlets can be used with or without one or more air distributors to direct, circulate, and/or distribute air within the oven chamber. The term “air,” as used herein, can include ambient air, oxygen, oxidizers, nitrogen, nitrous oxide, diluents, combustion gases, air mixtures, oxidizer mixtures, flue gas, recycled vent gas, steam, gases having additives, inerts, heat absorbers, liquid phase materials such as water droplets, multiphase materials such as liquid droplets atomized via a gaseous carrier, aspirated liquid fuels, atomized liquid heptane in a gaseous carrier stream, fuels such as natural gas or hydrogen, cooled gases, other gases, liquids, or solids, or a combination of these materials. In various embodiments, the air inlets and/or distributors can function (i.e., open, close, modify an air distribution pattern, etc.) in response to manual control or automatic advanced control systems. The air inlets and/or air distributors can operate on a dedicated advanced control system or can be controlled by a broader draft control system that adjusts the air inlets and/or distributors as well as uptake dampers, sole flue dampers, and/or other air distribution pathways within coke oven systems.

In operation, volatile gases emitted from input materials positioned inside the oven chamber 112 can collect in the crown and be drawn downstream into downcomer channels 118 formed in one or both sidewalls 108. The downcomer channels 118 can fluidly connect the oven chamber 112 with a sole flue 120, which is positioned beneath the oven floor 102. The sole flue 120 can form a circuitous path beneath the oven floor 102. Volatile gases emitted from the input materials can be combusted in the sole flue 120, thereby generating heat to support the processing of the input materials to produce processed materials (e.g., reduction of coal into coke). The downcomer channels 118 are fluidly connected to uptake channels 122 formed in one or both sidewalls 108. A secondary air inlet 124 can be provided between the sole flue 120 and atmosphere, and the secondary air inlet 124 can include a secondary air damper 126 that can be positioned at any of a number of positions between fully open and fully closed to vary the amount of secondary airflow into the sole flue 120. The uptake channels 122 are fluidly connected to a common tunnel 128 by one or more uptake ducts, such as the set of uptake ducts 130. A tertiary air inlet 132 can be provided between the set of uptake ducts 130 and atmosphere. The tertiary air inlet 132 can include a tertiary air damper 134, which can be positioned at any of a number of positions between fully open and fully closed to vary the amount of tertiary airflow into the set of uptake ducts 130.

Each respective uptake duct of the set of uptake ducts 130 includes a respective uptake damper of the set of uptake dampers 136 that can be used to control gas flow through the respective uptake duct and within the oven 100. An uptake damper of the set of uptake dampers 136 can be positioned at any number of positions between fully open and fully closed to vary the amount of oven draft in the oven 100. The uptake damper of the set of uptake dampers 136 can comprise any automatic or manually controlled flow control or orifice blocking device (e.g., any plate, seal, block, etc.). For example, the uptake damper of the set of uptake dampers 136 is set at a flow position between 0 and 2, which represents “closed,” and 24, which represents “fully open.” It is contemplated that even in the “closed” position a respective uptake damper of the set of uptake dampers 136 can still allow the passage of a small amount of air to pass through a corresponding uptake duct of the set of uptake ducts 130. Similarly, it is contemplated that a small portion of the uptake damper of the set of uptake dampers 136 can be positioned at least partially within a flow of air through the uptake duct of the set of uptake ducts 130 when the uptake damper of the set of uptake dampers 136 is in the “fully open” position. It will be appreciated that the uptake damper can take a nearly infinite number of positions between 0 and 24. Some exemplary settings for the set of uptake dampers 136, increasing in the amount of flow restriction, include: 22, 20, 8, and 6. In some embodiments, the flow position number simply reflects the use of a 14-inch uptake duct, and each number represents the amount, in inches (or some other length), that one or more uptake ducts of the set of uptake ducts 130 is open. Otherwise, it will be understood that the flow position number scale of 0-24 can be understood simply as incremental settings between open and closed.

As used herein, “draft” indicates a negative pressure relative to atmosphere. For example, a draft of 0.2 inches of water indicates a pressure of 0.2 inches of water below atmospheric pressure. Inches of water is a non-SI unit for pressure and is conventionally used to describe the draft at various locations in a coke plant. In some embodiments, the draft ranges from about 0.22 to about 0.26 inches of water. If a draft is increased or otherwise made larger, the pressure moves further below atmospheric pressure. If a draft is decreased, drops, or is otherwise made smaller or lower, the pressure moves toward atmospheric pressure. By controlling the oven draft with the set of uptake dampers 136, the airflow into the oven 100 from the set of crown air inlets 114, as well as air leaks into the oven 100, can be controlled. Typically, as shown in FIG. 2, an oven 100 includes two uptake ducts, such as the set of uptake ducts 130, and two uptake dampers, such as the set of uptake dampers 136, but the use of two uptake ducts and two uptake dampers is not a necessity; a system can be designed to use just one or more than two uptake ducts and two uptake dampers.

During operations of the operation, processed materials (e.g., coke, char, biochar) are produced in the oven 100 by first charging an input material into the oven chamber 112, heating the input material in an oxygen-limited (e.g., oxygen-depleted) environment, driving off the volatile fraction of the input material, and then oxidizing the VM within the oven 100 to capture and use the heat given off. Furthermore, the input material can include processed material produced by a previous heating operation and can include breeze or other types of coke fines. The input material can also include organics-derived carbon sources, such as wood, biomass, or biochar. As described elsewhere, inclusion of previously wasted breeze with heterogeneous or organics-derived carbon sources into input material can drastically improve the overall material efficiency of coke product production operations in the oven 100.

For example, the input material can include a carbon-containing feedstock, e.g., coal. The coal volatiles are oxidized within the oven 100 over an extended coking cycle and release heat to regeneratively drive the carbonization of the coal to coke. The coking cycle begins when the pusher side oven door 104 is opened and coal is charged onto the oven floor 102 in a manner that defines a coal bed. Heat from the oven (due to the previous coking cycle) starts the carbonization cycle. In many embodiments, no additional fuel other than that produced by the coking process is used. Roughly half of the total heat transfer to the coal bed is radiated down onto the top surface of the coal bed from the luminous flame of the coal bed and the crown 110. The remaining half of the heat is transferred to the coal bed by conduction from the oven floor 102, which is convectively heated from the volatilization of gases in the sole flue 120. In this way, a carbonization process “wave” of plastic flow of the coal particles and formation of high-strength cohesive coke proceeds from both the top and bottom boundaries of the coal bed.

In some embodiments, each oven 100 is operated at negative pressure so air is drawn into the oven during the reduction process due to the pressure differential between the oven 100 and atmosphere. Primary air for combustion is added to the oven chamber 112 to at least partially oxidize the volatiles from the input material. In some embodiments, the amount of this primary air is controlled so that only a portion of the volatiles released from the coal are combusted in the oven chamber 112, thereby releasing only a fraction of their enthalpy of combustion within the oven chamber 112. In various embodiments, the primary air is introduced into the oven chamber 112 above the coal bed through the set of crown air inlets 114, with the amount of primary air controlled by the air dampers 116. In other embodiments, different types of air inlets can be used without departing from aspects of the present technology. For example, primary air can be introduced to the oven through air inlets, damper ports, and/or apertures in the oven sidewalls or doors. Regardless of the type of air inlet used, the air inlets can be used to maintain the desired operating temperature inside the oven chamber 112. Increasing or decreasing primary airflow into the oven chamber 112 through the use of air inlet dampers can increase or decrease VM combustion in the oven chamber 112 and, hence, temperature.

An oven 100 can be provided with the set of crown air inlets 114 configured, in accordance with embodiments of the present technology, to introduce combustion air through the crown 110 and into the oven chamber 112. In one embodiment, three inlets of the set of crown air inlets 114 are positioned between the pusher side oven door 104 and a midpoint of the oven 100 along an oven length. Similarly, three inlets of the set of crown air inlets 114 are positioned between the output side oven door 106 and the midpoint of the oven 100. It is contemplated, however, that one or more inlets of the set of crown air inlets 114 can be disposed through the crown 110 at various locations along the oven's length. The chosen number and positioning of the crown air inlets depends, at least in part, on the configuration and use of the oven 100. Each crown air inlet of the set of crown air inlets 114 can include an air damper of the air dampers 116, which can be positioned at any of a number of positions between fully open and fully closed, to vary the amount of airflow into the oven chamber 112. In some embodiments, the air damper of the set of air dampers 116 may, in the “fully closed” position, still allow a small amount of ambient air to pass through the inlet of the set of crown air inlets 114 into the oven chamber. Accordingly, various embodiments of the set of crown air inlets 114, uptake elbow air inlet, or door air inlet can include a cap that can be removably secured to an open upper end portion of the particular air inlet. The cap can substantially prevent weather (such as rain and snow), additional ambient air, and other foreign matter from passing through the air inlet. It is contemplated that the oven 100 can further include one or more distributors configured to channel/distribute airflow into the oven chamber 112.

In various embodiments, the set of crown air inlets 114 are operated to introduce ambient air into the oven chamber 112 over the course of the heat processing cycle much in the way that other air inlets, such as those typically located within the oven doors, are operated. However, use of the set of crown air inlets 114 provides a more uniform distribution of air throughout the oven crown, which has shown to provide better combustion, higher temperatures in the sole flue 120, and later crossover times when the reactions in the oven 100 change from an exothermic process to an endothermic process. The uniform distribution of the air in the crown 110 of the oven 100 reduces the likelihood that the air will contact the surface of the feedstock bed and create hot spots that create burn losses on the feedstock surface. Rather, the set of crown air inlets 114 substantially reduces the occurrence of such hot spots, creating a uniform feedstock bed surface as the heat processing proceeds. In particular embodiments of use, the air dampers 116 of each of the set of crown air inlets 114 are set at similar positions with respect to one another. Accordingly, where an air damper of the air dampers 116 is fully open, all of the air dampers 116 can be placed in the fully open position; if the air damper of the air dampers 116 is set at a half-open position, all of the air dampers 116 can be set at half-open positions. However, in particular embodiments, the air dampers 116 can be changed independently from one another. In various embodiments, the air dampers 116 of the set of crown air inlets 114 can be opened up quickly after the oven 100 is charged or right before the oven 100 is charged. A first adjustment of the air dampers 116 to a ¾ open position is made at a time when a first door hole burning would typically occur. A second adjustment of the air dampers 116 to a 2/2 open position is made at a time when a second door hole burning would occur. Additional adjustments are made based on operating conditions detected throughout the oven 100.

The partially combusted gases pass from the oven chamber 112 through the downcomer channels 118 into the sole flue 120 where secondary air is added to the partially combusted gases. The secondary air is introduced through the secondary air inlet 124. The amount of secondary air that is introduced is controlled by the secondary air damper 126. As the secondary air is introduced, the partially combusted gases are more fully combusted in the sole flue 120, thereby extracting the remaining enthalpy of combustion that is conveyed through the oven floor 102 to add heat to the oven chamber 112. The fully or nearly fully combusted exhaust gases exit the sole flue 120 through the uptake channels 122 and then flows into the set of uptake ducts 130. Tertiary air is added to the exhaust gases via the tertiary air inlet 132, where the amount of tertiary air introduced is controlled by the tertiary air damper 134 so that any remaining fraction of non-combusted gases in the exhaust gases is oxidized downstream of the tertiary air inlet 132. At the end of the heat processing cycle, the input material has been processed to produce processed materials. The processed materials can be removed from the oven 100 through the output side oven door 106 utilizing a mechanical extraction system, such as a pusher ram. Finally, the processed materials can be quenched (e.g., wet or dry quenched). In some embodiments, the oven 100 can be configured to allow the processed materials to cool before the processed materials are removed from the oven 100. At least a portion of the heat from the cooling of the processed materials inside the oven 100 or outside the oven 100 can be recycled and utilized. For instance, the heat from the cooling of the processed materials inside the oven 100 can be used to maintain the temperature inside the oven 100 or dry fresh input material. As another example, the heat from the cooling of the processed materials inside the oven 100 can be used to preheat fresh input material before it is fed to the oven 100 or heat water to generate steam that can be used redistribute heat to other portions of the oven 100.

### III. Blend Creation and Pre-Processing

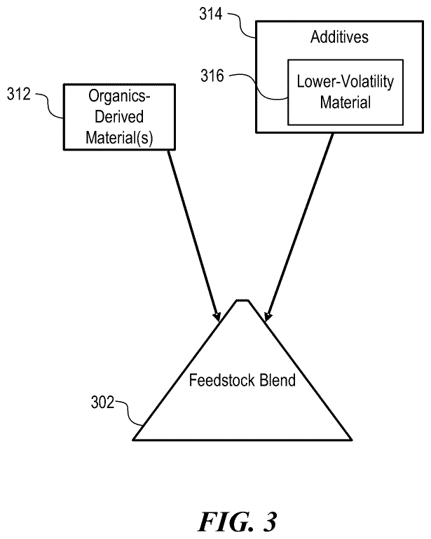

FIG. 3 depicts a feedstock blend, in accordance with embodiments of the present technology. Embodiments of the present technology can generate a feedstock blend 302 for use as input material. The feedstock blend 302 includes a set of organics-derived materials 312 and a set of additives 314, where the set of additives includes a set of lower-volatility materials 316 relative to the organics-derived materials 312.

In some embodiments, the set of organics-derived materials 312 can include carbonaceous materials such as biomass, which can be formed by heating organic material in a low-oxygen environment. The biomass can be formed from a variety of feedstocks, including agricultural waste, wood chips, natural rubber, and other biomass materials. Furthermore, the set of organics-derived materials 312 can include biochar produced by non-biomass materials, such as synthetic rubber, or a polymeric material, such as polyethylene. As described elsewhere, the use of biochar in the set of organics-derived materials 312 after being blended into the feedstock blend 302 can result in significant expansion when the feedstock blend 302 is placed in an oven. While such expansion is traditionally problematic for coke production, operations described in this disclosure can overcome such difficulties by using operations that include heating the feedstock blend 302 to a temperature greater than 1,000° F., such as 1,100° F., 1,200° F., 1,300° F., etc.

In some embodiments, the set of organics-derived materials 312 can include various types of biologically derived material, such as whole logs, tree stumps, etc. For example, the set of organics-derived materials 312 can include a log having a cross section that is at least 100 millimeters (mm), 250 mm, 500 mm, 1.0 meters (m), or some other value. As described elsewhere in this disclosure, the use of higher temperatures and pelletizing operations can overcome conventional expansion problems encountered with the use of organic materials for coke production.

The feedstock blend 302 also includes materials obtained from the set of additives 314. The set of additives 314 can include metallic materials, metal-containing materials, or minerals. For example, the set of additives 314 can include iron, carbon steel, cast iron, etc. Alternatively, or additionally, the set of additives 314 can include minerals, such as calcium oxides, other oxide-containing minerals, calcium hydroxides, other hydroxide-containing minerals, etc. The set of additives 314 can also include other carbon-containing materials, such as petroleum pitch, polypropylene, polystyrene, polyethylene, rubber, other polymeric materials, etc.

The set of additives 314 can also include the set of lower-volatility materials 316, which can include various types of carbon-containing materials that have a lesser volatility than biochar material or other material derived from organic matter obtained from the set of organics-derived materials 312. For example, the set of lower-volatility materials 316 can include at least one of charcoal fines, coal fines, crushed foundry coke breeze, petroleum coke breeze, or coke breeze. In some embodiments, the set of lower-volatility materials 316 includes coke fines that have been produced from a previous heating operation using an oven, such as the oven 100. In some embodiments, the set of lower-volatility materials 316 are transported from elsewhere. The set of lower-volatility materials 316 can be mixed with additional particulate material from a source other than the heat processing of the input material. Such additional particulate materials can include, e.g., anode waste, a raw particulate material (e.g., iron fines, other metal fines), spent activated carbon, a particulate material from another processing (e.g., blast furnace dust, baghouse fines, waste materials, petroleum coke breeze, anthracite fines, calcined anthracite fines), or the like, or a combination thereof. Additional examples of such particulate materials include iron ore pellet fines, Direct Reduced Iron (DRI) pellet fines, DRI/Hot Briquetted Iron (HBI) pellet fines, quench pond dippings (QPD), spilled coal and coke recovery materials, coal wash plant refuse material, or the like, or a combination thereof. Furthermore, the set of lower-volatility materials 316 can include sulfur-containing material having a lesser volatility than biochar in the set of organics-derived materials 312, such as a high sulfur petroleum coke.

In some embodiments, the set of organics-derived materials 312 can include sulfur-containing carbonaceous materials. For example, the set of organics-derived materials 312 can include high sulfur coal, where the high sulfur coal can include a coal having a weight fraction of sulfur relative to the coal that is greater than 1.0%, greater than 2.0%, greater than 3.0%, or greater than 5.0%. Though conventional coke production methods discourage the use of high sulfur coal for coke production, some embodiments overcome this deficiency by exposing the set of organics-derived materials 312 with a desulfurizing agent to remove some of the sulfur compounds and make the coal more suitable for use in coke production. For example, in some embodiments, a quench pond system can dip the set of organics-derived materials 312 in a quench pond containing a desulfurizing agent to reduce a sulfur content of the set of organics-derived materials 312 or dip the feedstock blend 302 in a quench pond containing a desulfurizing agent to reduce a sulfur content of the set of organics-derived materials 312.

As described elsewhere in this disclosure, embodiments of the present technology can determine the composition of the blend 302 by configuring an output model using a set of oven parameters and other processing parameters, and then using the configured model to determine what combination of materials will produce an output material that satisfies a set of target properties. For example, embodiments of the present technology can determine a ratio of materials to use when determining the composition of the blend 302 by obtaining a target VM value. Embodiments of the present technology can then determine a set of oven parameters based at least in part on the target VM, where the set of oven parameters have been indicated to produce an output material having the target VM in the model, where the model can output a set of predicted VM values based on input material VM values and corresponding release rates. Embodiments of the present technology can then use the configured model in combination with a known VM of the biochar in the set of organics-derived materials 312, a known VM release rate of the biochar, a known VM of a lower-volatility material in the set of lower-volatility materials 316, and a known VM release rate of the lower-volatility material to determine a model output. The model output can then provide a material ratio indicating a ratio of an amount of the lower-volatility material from the set of lower-volatility materials 316 to use to an amount of the biochar from the set of organics-derived materials 312 to use in the blend 302.

In some embodiments, the feedstock blend 302 can be used as the input material for an oven. The feedstock blend 302 can include at least one of carbon, nitrogen, oxygen, sulfur, an alkali metal, aluminum, iron, a transition metal, or the like, or a combination thereof. In some embodiments, the input material can include at least one of a carbonaceous feedstock, a non-metal feedstock, or a metal-containing feedstock. In some embodiments, the carbonaceous feedstock can include at least one of coal, wood, a petroleum residue, a biomass feedstock, or a waste feedstock. In some embodiments, the non-metal feedstock can include a nitrogen-containing feedstock (e.g., a material that is high in nitrogen), limestone (CaCO₃), or quartz (SiO₂). In some embodiments, the metal-containing feedstock can include a raw mineral material or a recycled metal-containing material. In some embodiments, the transition metal can include at least one of copper, iron, cobalt, vanadium, zinc, nickel, chromium, manganese, scandium, titanium, gold, hafnium, molybdenum, tungsten, silver, platinum, ruthenium, rhodium, niobium, zirconium, technetium, iridium, osmium, palladium, tantalum, yttrium, rutherfordium, cadmium, rhenium, roentgenium, seaborgium, dubnium, hassium, meitnerium, bohrium, darmstadtium, or copernicium. The input material can include at least one component of interest that can also be included in the particulates and/or produced pellets.

In some embodiments, the feedstock blend 302 can be provided to an oven, such as the oven 100. The particulates produced by the heat processing of the feedstock in the oven, and/or the additional particulate materials to be mixed with the particulates produced by the heat processing of the feedstock in the oven, can include minerals, metal oxides, metal halides, metal sulfates, aluminum and silicon minerals, industrial waste, recycle streams, or unwashed coal. Examples of the minerals include limestone, dolomite, trona, calcium bearing, iron bearing (e.g., hematite, magnetite), magnesium bearing, or the like, or a combination thereof. Examples of the metal oxides include Al₂O₃, SiO₂, CaO, Fe₂O₃, MgO, Na₂O, TiO, a transitional metal oxide, a calcined mineral, or the like, or a combination thereof. Examples of the metal halides include CaCl₂), MgCl₂, NaCl, or the like, or a combination thereof. Examples of the metal sulfates include CaSO₄, or the like, or a combination thereof. Examples of the aluminum and silicon minerals include quartz, muscovite, feldspar, or the like, or a combination thereof. Examples of the industrial waste and recycle streams include blast furnace slag (or referred to as blast furnace dust), foundry cupola slag, metal fines, wallboard waste, flue gas desulfurization (FGD) waste (e.g., fly ash), coal burning plant fly ash, or heat recovery steam generator (HRSG) wash mud, or the like, or a combination thereof.

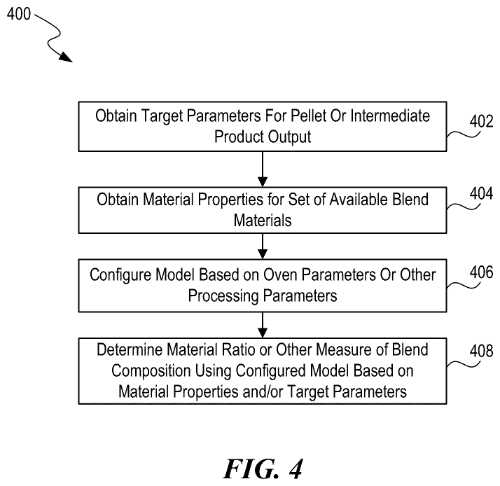

FIG. 4 is a flowchart of a method 400 for determining a blend composition, in accordance with embodiments of the present technology. In some embodiments, a controller and/or one or more processors in one or more of the systems described in this disclosure can perform some or all of the operations of the method 400 or other methods described in this disclosure.

The method 400 can include obtaining a set of target parameters for a pellet or intermediate product output (process portion 402). The set of target parameters can include a property, a dimension, or another characteristic of an oven output or a product used to produce a pellet. A property of a material can include material properties, a material composition, or other physical properties. For example, embodiments of the present technology can obtain a target VM amount, a target ash fusion temperature, a target reactivity index, or some other property of an oven product or a downstream product produced from the oven product (e.g., a pellet formed from a treated oven product). For example, embodiments of the present technology can obtain a target VM amount of a pellet as a target parameter, where embodiments of the present technology can use one or more models to determine a quantitative relationship between a VM amount and a selected blend of materials, treatment parameters, and oven parameters.

The method 400 can include obtaining properties for a set of available blend materials (process portion 404). In some embodiments, the known properties used in this disclosure can be the same type of properties obtained for process portion 402. For example, a blend planning system can obtain a percentage representing a target VM amount for a biochar-produced pellet. The target VM amount for the pellet, represented as a percentage, can be no more than 15%, 10%, 8%, 7%, 6%, 5%, 4%, 3%, 2%, 1%, 0.5%, or 0.1%, or within a range of 0.1-15%. The blend planning system can then obtain a set of VM amounts for a set of available materials to use in a blend, where the set of VM amounts can include a biochar VM amount for biochar in a set of available blend materials and a VM amount in one or more lower-volatility materials. For example, the blend planning system can obtain a first percentage representing a biochar VM amount, where the first percentage is between the ranges of 10% to 90% or 20% to 80%, and obtain a second percentage representing a VM amount for coke fine, where the second percentage is between 0% to 15% or 1% to 10%. It should be understood that other properties can be used, such as a biochar ash fusion temperature of a biochar usable for an input blend, an ash fusion temperature of another material available for use in the input blend, a biochar reactivity index, or another reactivity index of another material available for use in the input blend.

In some embodiments, additional properties of one or more types that are different from a target property can be used when determining the composition of a blend used to produce a product having a target property. For example, after obtaining a target VM amount, embodiments of the present technology can obtain both the VM amounts for a set of possible materials to use in a blend as well as VM release rate parameters for the set of possible materials, where a release rate parameter can include a release rate itself, a constant parameter of a temperature-dependent release rate (e.g., either or both the parameter Kᵣₑₗₑₐₛₑ or K₀ in the release rate parameter R=Kᵣₑₗₑₐₛₑ T+K₀), or another constant parameter of a release rate model. Embodiments of the present technology can then use both the VM amounts and VM release rate parameters to use as inputs for a prediction model. For example, embodiments of the present technology can obtain a biochar VM amount, a biochar VM release rate parameter, a coke VM amount, and a coke VM release rate parameter. As described elsewhere in this disclosure, embodiments of the present technology can then provide all four parameters to a prediction model used to predict oven output properties or pellet properties in order to determine a corresponding blend composition using a polynomial model, power law model, some combination of polynomial and power law model, or another model.

Embodiments of the present technology can use a binning system to estimate a biochar VM amount based on a biochar classification. For example, some embodiments may assign a VM amount. For example, embodiments of the present technology can obtain a category for a biochar without being provided a numeric value for the VM amount of the biochar. Embodiments of the present technology can then assign a VM amount to the biochar material when performing operations to determine a blend composition. For example, embodiments of the present technology can obtain an indication that a possible biochar material for a blend is a “class I” biochar material and, in response, assign the biochar VM amount “25%” to the possible biochar material. Embodiments of the present technology can then assign the VM amount “50%” in response to being provided with information indicating that a second possible biochar is a “class II” biochar material. Other categories and associated values representing different properties are possible.

The method 400 can include configuring a model based at least in part on a set of oven parameters or other processing parameters (process portion 406). A model configured based on oven parameters or other processing parameters can include an empirical model or semi-empirical model. The model can indicate positive or negative correlations between properties of an oven output or product derived from the oven output and one or more parameters of a material used in an oven input blend. For example, embodiments of the present technology can use a model that indicates a positive correlation between the initial VM amount of the materials used in an input blend and the VM amount of an oven output or product generated from the oven output. In some embodiments, the empirical model can include a first model term that is correlated with a processing parameter.

In some embodiments, the model can include a simulation model. For example, embodiments of the present technology can use a semi-empirical simulation model to simulate the effect of an oven operation that includes a first period during which temperature is elevated, a second period during which temperature is maintained, and a third period during which temperature is reduced. Furthermore, the simulation can account for the airflow, pressure, and other conditions in an oven and can be simulated using simulation software such as Aspen HYSYS, Prosim Batch, ANSYS Fluent, or another simulation software. Furthermore, embodiments of the present technology can use the simulation software to simulate operations to produce multiple oven outputs using multiple oven parameters, material properties, and blend compositions. Embodiments of the present technology can then provide the inputs and outputs to a machine learning model to train the machine learning model to predict outputs based at least in part on the set of inputs.

Some embodiments may determine one or more oven parameters to control the operations of an oven. The oven parameters used to control an oven may have a strong influence on the pellet parameters of a coke pellet or other pellet generated using operations described in this disclosure. For example, some embodiments may iteratively use a simulation to predict the output materials of an oven and then simulate modifications to the oven operations to match a set of target pellet parameters. Example pellet parameters may include a target pellet moisture, a target pellet strength, a target pellet density, a target pellet size, a target pellet sulfur content, or a target pellet ash fusion temperature. For example, some embodiments can determine, as part of a set of target pellet parameters, a pellet density, a pellet pore size, a pellet geometry, a pellet VM, or mechanical property (e.g., stiffness, elasticity, plasticity). After simulating the use of a set of candidate operational parameters of an oven that, if implemented, would result in a pellet having the set of target pellet parameters, some embodiments can use set of the candidate operational parameters as actual operational parameters used to control oven operations.

The method 400 can include determining a material ratio or other measure of blend composition using the configured model based on the material properties and/or target parameters (process portion 408). A blend selection system can determine a ratio of different materials used in an input blend based at least in part on a configured model, one or more target parameters, and one or more properties of materials usable for the input blend. For example, if the available materials for the input blend include a biochar material and a lower-volatility material, such as a coke fine material, a blend selection system can obtain the biochar VM amount, the biochar VM release rate parameter, a VM amount for the lower-volatility material, and a VM release rate parameter for the lower-volatility material. The blend selection system can then configure a model based at least in part on an obtained set of oven parameters representing an oven cooking process (e.g., different heating periods and target temperatures or target pressures for those different heating periods). Alternatively, a blend selection system can obtain a preconfigured model. For example, the blend selection system can select a first set of model parameters from a plurality of model parameters to configure a model based at least in part on a set of oven parameters or other material processing parameters.

A blend selection system can then determine a ratio by using the configured model and the set of input parameters to determine a ratio. In some embodiments, the configured model can explicitly provide a ratio of materials. For example, a blend selection system can configure a model implemented as a set of functions provide the set of functions with a biochar VM amount, a biochar VM release rate parameter, a VM amount for the lower-volatility material, and a VM release rate parameter for the lower-volatility material. The blend selection system can then generate a ratio indicating an amount of the lower-volatility material to an amount of the biochar in an input blend. For example, a function can output a percentage of biochar material and a percentage of coke fine material. Furthermore, it should be understood that a ratio can provide information for more than two components. For example, if a set of available materials for use in an input blend includes coke fines, calcium carbonate materials, and biochar materials, embodiments of the present technology can output a ratio indicating an amount of the biochar material to the coke fine material by providing percent compositions for each of the coke fines, calcium carbonate material, and the biochar material.

Furthermore, while the above example indicates the use of VM amounts and VM release rates, it should be understood that other parameters can be used, such as ash fusion values or reactivity indices. For example, a blend selection system can use a configured ash fusion prediction model to predict candidate ash fusion values based at least in part on a set of ash fusion values of input materials and ratio of the input materials, such as a biochar and coke fines (or another lower-volatility material). A blend selection system can then determine that at least one of the determined candidate ash fusion values match with a target ash fusion value and select the ratio of the input materials used to output the target ash fusion value. Alternatively, a blend selection system can use a configured model based at least in part on a set of ash fusion values to predict candidate reactivity indices based at least in part on a set of reactivity indices of possible input materials, such as a biochar reactivity index and a reactivity index of a lower-volatility material. The blend selection system can then determine that at least one of the determined candidate reactivity indices matches with a target reactivity index and select the ratio of the input materials used to output the target reactivity index.

Alternatively, embodiments of the present technology can use a combination of different parameters to confirm a proposed candidate ratio. For example, embodiments of the present technology can determine a candidate ratio by providing a first prediction model with a set of VM amounts characterizing possible materials for an input blend. Embodiments of the present technology can then provide the same or a different set of properties for the possible materials and the candidate ratio to one or more other models to confirm that the ratio satisfies other target parameters. For example, embodiments of the present technology can provide the candidate ratio to an ash fusion prediction model in conjunction with the ash fusion values corresponding with the candidate ratio to predict a candidate ash fusion value. Embodiments of the present technology can then accept or reject the candidate ratio based on whether the candidate ash fusion value is within a preset tolerance range of a target ash fusion value. Alternatively, or additionally, embodiments of the present technology can provide the candidate ratio to a reactivity index prediction model in conjunction with the reactivity indices corresponding with the candidate ratio to predict a candidate reactivity index. Embodiments of the present technology can then accept or reject the candidate ratio based on whether the candidate reactivity index is within a preset tolerance range of a target reactivity index.

Furthermore, embodiments of the present technology can determine additional candidate parameters by using an interpolation method or a machine learning method to determine the ratio of the input materials in cases where a set of directly computed candidate parameters do not match a target parameter.

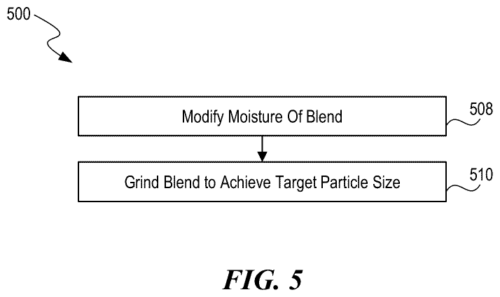

FIG. 5 is a flowchart of a method for performing blend pre-processing for a feedstock before charging the feedstock into an oven, in accordance with embodiments of the present technology. The method 500 can include modifying the moisture of a blend (process portion 508). In some embodiments, input material for an oven, such as the feedstock blend 302, can be processed with one or more types of pre-processing treatments before being received by the oven. The blend can be a blend of breeze and other carbonaceous material, such as biochar, or any other input materials described herein. For example, with reference to FIG. 3, the blend can be the blend 302. In some embodiments, a hydration assembly can include a water injection system, where an amount of water added to the blend can be based at least in part on a weight of the blend and added to the blend until a volumetric fraction threshold or mass fraction threshold is satisfied. For example, the volumetric fraction or mass fraction threshold can be a value less than 1%, a value less than 5%, a value less than 10%, a value less than 25%, or a value less than 50%.

Embodiments of the present technology can hydrate an input blend based at least in part on a moisture parameter and a mass of the input blend. A moisture parameter can include a parameter indicating a degree to which a material is hydrated and can include a volumetric fraction, a mass fraction, a percent saturation, etc. For example, some embodiments determine an amount of water based at least in part on the mass of the input blend and weight percentage and, in response, spray the amount of water on the input blend using a nozzle.

A moisture content of a blend being charged into an oven can influence a target particle size of the resulting oven output. Embodiments of the present technology can obtain or configure a particle size model that provides a particle size based at least in part on a moisture parameter and a set of oven parameters. In some embodiments, the target particle size can indicate a target size for particles in an oven output. Alternatively, the target particle size can indicate a target size for particles in a downstream product of the oven output, such as a coke pellet. Embodiments of the present technology can then use the model to determine a moisture parameter by using interpolation or by reversing a function of the model.

When hydrating a blend, some embodiments may dispense the input blend from a hopper storing the input blend onto a tray via a hopper port. For example, some embodiments obtain an input blend of various materials including biochar and store the input blend into a hopper that includes a hopper port and a hopper actuator that controls flow through the hopper port. Some embodiments may then activate the hopper actuator that allows the input blend to escape the hopper through the hopper port. In some embodiments, the tray may include a rotating plate that is connected to a rotary actuator. Some embodiments may also control a nozzle that is directed to the input blend on the rotating plate. During operations of the method 400, some embodiments may concurrently rotate the rotating plate by activating the rotary actuator while hydrating the input blend on the plate with the nozzle. Furthermore, after hydration, some embodiments may further activate an actuator to mechanically mix the input blend after hydration. For example, some embodiments may move a tray storing a hydrated input blend underneath a mixing arm and actuate the mixing arm to mechanically mix the input blend.

In some embodiments, modifying the moisture of the blend can include decreasing the moisture, e.g., by drying the blend via convection, conduction, radiation, or other means using one or more heat sources. The heat sources can include flue gas and/or waste heat recovery streams produced via the oven (e.g., the oven 100) or other system component. The moisture of the blend can be decreased based on desired particle size of the processed product, a mass of the blend, and/or other factor.

The method 500 can include grinding a blend to achieve a target particle size (process portion 510). Some embodiments can mill or grind the blend to reduce particle dimensions before providing the blend to an oven for heating. To grind a material, some embodiments can use a ball mill, a rod mill, or another type grinding machine. Furthermore, some embodiments can obtain a target size distribution as a target parameter, and use a prediction model to predict a set of grinder operational parameters corresponding with the target size distribution. For example, a pre-processing system can include a device, e.g., a grinder, configured to reduce the size of the input material before the input material is combusted in an oven, such as the oven 100. In some embodiments, the grinder or some other component of a production system can reduce a size of components of the input material to have a smallest cross-sectional dimension of at least 2 inches, 3 inches, 4 inches, 5 inches, or 6 inches, where such dimension thresholds can represent a target particulate size range. In some embodiments, the grinder or downstream sorter can be configured such that no more than a permitted tolerance of particle population is allowed above a size threshold, where the permitted tolerance can be less than 1%, less than 5%, less than 10%, less than 25%, etc. For example, the grinder can be configured such that no more than 5% of an input material for an oven has a length that is greater than a preset dimension threshold equal to 4 inches.

Various machinery or equipment may be involved with grinding or other pre-oven processing operations. For example, some embodiments may use a hammer to stamp charge an input blend to make particle size more uniform and/or increase material homogeneity. To use a hammer, some embodiments may activate a conveyor that moves a tray holding an input blend (e.g., a tray of a hydrated input blend) under a stamp charge hammer and then stamp the input blend with the hammer. The stamping operations may serve to both mix the input blend and grind the input blend. Furthermore, some embodiments may use an empirical function to determine a set of operational parameters of equipment used for mixing or grinding to achieve a target distribution of blend of particle sizes. For example, some embodiments may obtain a function to compute a hammer speed to satisfy a target distribution blend of particle sizes. Some embodiments may then operate the hammer to crush/grind input material at the computed hammer speed. Some embodiments may then transport the stamped input blend into an oven for heating operations.

### IV. Oven Operation

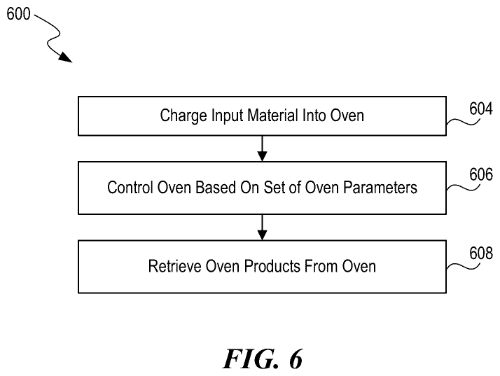

FIG. 6 is a flowchart of a method to produce output particulates using a production system, in accordance with embodiments of the present technology. In some embodiments, an input blend for an oven of a production system can include a feedstock blend, such as the feedstock blend 302. In some embodiments, an input plurality of particles used as an input blend in the method 600 can be processed with one or more operations described for the method 400 before being received by the oven.

The method 600 can include charging input material into an oven (process portion 604). In some embodiments, a first plurality of particles being used as an input material for an oven can be charged into the oven with the use of a tray loading mechanism. For example, embodiments of the present technology can include a conveyor belt and a set of arms or paddles to transfer a first plurality of particles onto and off of the conveyor belt. The conveyor belt can then transport the first plurality of particles into an oven chamber, such as the oven chamber 112. Alternatively, or additionally, embodiments of the present technology can use a stainless steel cable to drag input material into the oven. As described elsewhere in this disclosure, the oven may then perform operations to convert the first plurality of particles into a second plurality of particles that, after one or more post-processing operations, can be used as a coke pellet.

The method 600 can include controlling the oven based on the set of oven parameters (process portion 606). The set of oven parameters may control various aspects of open operations, such as an amount airflow through the oven. For example, embodiments of the present technology can manipulate an uptake damper (e.g., one or more uptake dampers of the set of uptake dampers 136) to control gas flow through an uptake duct (e.g., an uptake duct of the set of uptake ducts 130). A production system can increase a draft amount by manipulating the uptake damper to increase a temperature of an oven. Furthermore, it should be understood that manipulation of an oven's uptake dampers or other components of an oven can occur concurrently with other oven operations to maintain a target heating environment, such as a target temperature, a target pressure, etc.

In some embodiments, the production system can begin heating an input material using a target set of oven parameters. The set of oven parameters may include a schedule of temperatures (e.g., assigning one or more temperatures for one or more durations), one or more draft control parameters to control a draft control system, or one or more heat exchanger parameters to influence heat flow within an oven (e.g., the flow rate of an oven heat exchanger). In some embodiments, the oven operations can be used to control an oven, where the oven can be a coke oven (e.g., the oven 100 as illustrated in FIGS. 1 and 2). In some embodiments, the oven can be a heat processing oven including, e.g., a devolatilization oven, a pyrolysis oven, or a blast furnace. In some embodiments, the processing of the input material in the oven can include a pyrolysis process to convert a first plurality of particles being used as an input blend into a second plurality of particles that includes one or more pyrolyzed products.

For example, some embodiments may determine a set of oven operations predicted to achieve a target output material property for pyrolyzed products that includes a first duration and a second duration. During the first duration, the temperature of an oven interior is set to a first temperature (e.g., at a temperature greater than or equal to 1,000° F.), a first heat exchanger flow rate (e.g., a rate less than or equal to 100 liters per second), and a draft control parameter indicating a first opening size of a draft control actuator. During the second duration, the temperature of the oven interior may be set to a second temperature (e.g., such that the second temperature is at least 1,200° F. for the second duration), a second heat exchanger flow rate, and a second draft control opening size. Some embodiments may control draft through an oven by controlling an angle of an uptake port of the oven. For example, some embodiments may perform operations to angle an uptake port of an oven to increase airflow through the oven. Additionally, it should be understood that a predicted heat exchanger flow rate may vary based on simulation results, which may be influenced by other plant operational parameters, plant size, etc. For example, a heat exchanger flow rate may be set to a rate less than or equal to 1.0 liters per second (L/s), a rate less than or equal to 10 L/s, a rate less than or equal to 100 L/s, a rate less than or equal to 1,000 L/s, etc.

One or more modifiers can be used in the heat processing. The one or more modifiers can include a mineral oxide modifier. Examples of modifiers include CaO, SiO₂, MgO, or the like, or a combination thereof. In some embodiments, the modifiers can be ash composition modifiers, gasification reaction modifiers, etc. The type and/or amount of the modifiers used can be determined or adjusted based on factors including, e.g., input material, component of interest in the input material and/or pellets to be produced, the devices used in the heat processing and/or pelletization, or the like, or a combination thereof. For instance, for the processing of an input material to produce a population of pellets, the CaO/SiO₂ ratio and MgO content in the heat processing cycle can be determined accordingly. The processed materials can include particulates. By way of the heat processing, volatiles can be removed from the input material. The content of a component of interest can be increased. One or more properties can also be improved or adjusted for subsequent application or processing. For instance, particulates of the processed materials can have one or more surface chemistries and/or morphological/microstructural properties that allow or facilitate pelletization thereof. Examples of such properties include surface areas, porosities, surface tensions, surface charges, pi-stacking sites, or the like, or a combination thereof, of the particulates so produced. Descriptions of the heat processing of the input material, including the operations parameters of the heat processing, the oven and the control thereof, the processed materials, particulates in the processed materials, etc., can be found elsewhere in the present disclosure and are not repeated here.

In some embodiments, the heat processing in an oven can proceed and be controlled by a control system. The input material can be processed in the oven for a processing duration. During at least a portion of the processing duration, the heat processing can proceed at a processing temperature of at least 1,000° F. In some embodiments, during at least a portion of the processing duration, the processing temperature can be at least 1,100° F., 1,200° F., 1,300° F., 1,400° F., 1,500° F., 1,600° F., 1,800° F., 2,000° F., or 2,500° F. In some embodiments, during at least a portion of the processing duration, the processing temperature can reach up to 2,800° F. In some embodiments, the processing duration can be no more than 5 days, 3 days, 2 days, 1 day, 18 hours, 12 hours, 8 hours, 6 hours, or 4 hours.

In some embodiments, the processing duration can be set before the heat processing starts. In some embodiments, the processing duration can be adjusted substantially in real time as the heat processing proceeds. In some embodiments, the processing duration can be determined or controlled based at least in part on an operation parameter relating to the heat processing in the oven. Exemplary operation parameters include at least one of a temperature at an opening of or at a location inside the oven, a composition of an exhaust (or referred to as exhaust gas) of the oven, a gas flow rate of the exhaust, or a temperature at an external surface of the oven.

In some embodiments, the combustion temperature and/or the duration of a combustion period in an oven can be determined or adjusted in a coordinated manner based on one or more considerations including, e.g., the input material (e.g., composition, dimension, or the like, or a combination thereof), an operation parameter relating to the heat processing as described above, a desired property of the processed materials, the particulates, and/or the produced pellets.

In some embodiments, the output rate of the oven can be in the range from 0.1 tons per hour to 1 ton per hour. In some embodiments, a production system can include multiple ovens. For example, the production system can include multiple ovens similar to the oven 100. The output rate of the production system that includes multiple ovens can be multiple times of the output rate of one oven. In some embodiments, at least two of the multiple ovens are thermally coupled such that one constitutes a source of heat to the other. For example, a production system can include a first oven and a second oven, where both ovens are similar to the oven 100. The second oven can be configured to heat materials that undergo an exothermic process, and at least a portion of the heat generated in the exothermic process in the second oven is transferred to the first oven, which is thermally coupled to the second oven. The duration of the exothermic process in the second oven can at least partially overlap with the heat processing of the input material in the first oven. In some embodiments, only a portion of the process in the second oven can be exothermic, and the exothermic portion of the process in the second oven can at least partially overlap with the heat processing of the input material in the first oven. As another example, a production system can include three ovens arranged side by side so that two side ovens are located on the opposite sides of the middle oven; at least one of the two side ovens can be thermally coupled with the middle oven such that the at least one side oven can constitute a source of heat to the middle oven.

In some embodiments, the processed materials can include particulates and materials of a larger dimension than the particulates. Merely by way of example with reference to the input material including coal, the processed materials can include coke and coke breeze. In some embodiments, the processed materials can include coke, char, biochar, coke breeze, char fines, or the like, or a combination thereof. In some embodiments, the processed materials can be processed (e.g., sized) to separate the particulates from the materials of a larger dimension. In some embodiments, the particulates can be further processed by way of, e.g., pelletization, as described elsewhere in the present disclosure.

The method 600 can include retrieving oven products from the oven (process portion 608). When removing the oven output particulates, embodiments of the present technology can push the output particulates into a container for ease of handling or transport. For example, embodiments of the present technology can push the output particulates into a container having a removable top container. Embodiments of the present technology can then accelerate cooling of the output particulates by using a liquid injection or liquid spray nozzle to expose the outside of the container (e.g., container sides, container top) to water, a coolant, or another type of liquid. Embodiments of the present technology can position the container on a rotating surface that rotates concurrently or in sequence with spraying operations to accelerate cooling. In some embodiments, a production system can process oven output particulates in multiple batches. By using a container to contain oven outputs, embodiments of the present technology can reduce the risk of dust contamination.

### V. Production Assembly

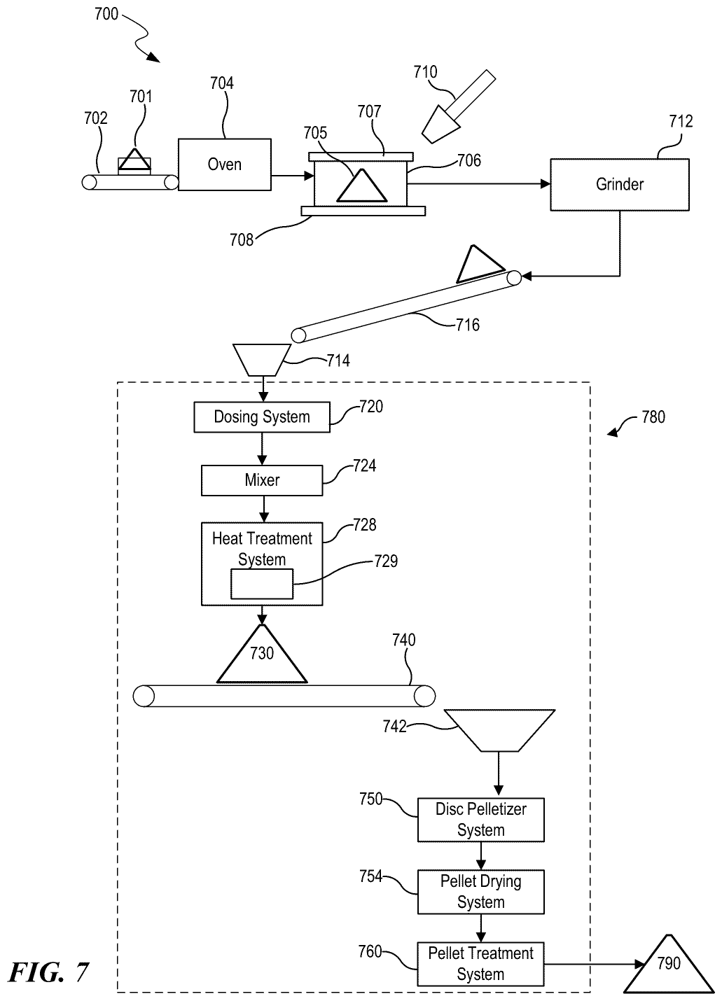

FIG. 7 depicts a schematic of a production system 700 in accordance with embodiments of the present technology. In some embodiments, the production system 700 includes an oven 704 and a pelletization assembly 780. The oven 704 can be identical to the oven(s) 100 described above with reference to FIGS. 1 and 2 or have any one or more of the features described therein. In some embodiments, the oven 704 can include a coke oven, a devolatilization oven, a pyrolysis oven, a blast furnace, or the like, or a combination thereof. Moreover, the oven 704 can be a heat recovery oven or a non-heat recovery oven (e.g., a byproduct oven). An input material (or referred to as feedstock) 701 can be provided to the oven 704 via a tray loading mechanism 702 and processed in the oven 704 at a processing temperature of at least 1,000° F. for a processing duration to produce processed materials. In some embodiments, the processing of an input material 701 in the oven 704 can include a pyrolysis process and the processed materials include pyrolysis products. The processed materials can include a set of particles 705, which can be pelletized in the pelletization assembly 780 to produce a population of pellets 790.

In some embodiments, the processed materials can include set of particles 705 and materials of a larger dimension than the particulates. In some embodiments, the processed materials can include coke, char, biochar, coke breeze, petroleum coke breeze, calcined anthracite fines, char fines, or the like, or a combination thereof. Merely by way of example with reference to an input material including coal, the processed materials can include coke and coke breeze. As another example with reference to an input material including wood, the processed materials can include char and char fines. As a further example with reference to an input material including biomass, the processed materials can include biochar and biochar fines. In some embodiments, the processed materials can be processed to separate the set of particles 705 from the materials of a larger dimension. For example, the separation can be performed manually or automatically using, e.g., a sieve.

In some embodiments, the set of particles 705 can include at least one of charcoal fines, coal fines, petroleum coke breeze, or coke breeze. In some embodiments, the set of particles 705 from the heat processing can be mixed with an additional particulate material from a source other than the heat processing of the input material. Such additional particulate materials can include, e.g., a raw particulate material (e.g., iron fines, other metal fines), a particulate material from another processing (e.g., blast furnace dust, baghouse fines, waste materials, petroleum coke breeze, anthracite fines, calcined anthracite fines), or the like, or a combination thereof. Additional examples of such particulate materials include iron ore pellet fines, DRI pellet fines, DRI/HBI pellet fines, QPD, spilled coal and coke recovery materials, coal wash plant refuse material, or the like, or a combination thereof. Such particulate materials can be unsuitable for an application directly. For example, unlike coke, coke breeze is unsuitable to be used in a blast furnace for steel making. In some cases, although such particulate materials can include useful compositions, due to the difficulty involved in using them directly, they are disposed, which often incurs a cost. Pellets including and/or made of such particulate materials can be used in various applications. The mixed particulate materials can be pelletized alone or mixed with the particulates produced in the heat processing of an input material described elsewhere in the present disclosure.

The production system 700 may include a container 706 to transport the set of particles 705 after the oven 704 produces the set of particles 705, and a nozzle system 710 that is directed toward the container 706. The container 706 can cool the set of particles 705 after being removed from the oven by removing or effectively snuffing out the oxygen. In some embodiments, the set of particles 705 can be cooled via a water spray (e.g., inside or outside the container 706), a dry-quench (e.g., using carbon dioxide), or other means (e.g., dry ice).

In some embodiments, the container 706 may be a flat push hot car (FPHC) or other conveyor vessel. In some embodiments, the FPHC may be rail-controlled or autonomously controlled. For example, some embodiments may provide an input to a controller attached to the container to direct the container to a target destination. The production system 700 can also include a rotating platform 708 that is underneath the container 706. During operation of the production system 700, the container 706 can move or be moved onto the rotating platform 708. In some embodiments of the present technology, the nozzle system 710 sprays water or another cooling material onto the container 706 as the rotating platform 708 rotates. Furthermore, the container 706 can include a top covering 707 that is above the walls of the container 706 and encloses the set of particles 705. After the top covering 707 is closed, the top covering 707 can protect the contents of the container 706 from water during a later cooling stage. For example, some embodiments can activate the rotating platform 708 to rotate the container 706 around the center of the container 706 while concurrently spraying the exterior of the container 706 to cool the set of particles 705 and any other material inside the container 706.

Furthermore, in some embodiments, the container 706 may be inside of a tubular structure when being exposed to a cooling fluid by the nozzle system 710 or when being otherwise exposed to the cooling fluid. Additionally, while not shown, the production system 700 may include an alternative cooling system. For example, after covering the top of the container 706 with the top covering 707, some embodiments can transport the container 706 into a tubular interior and activate a fan or pump that causes a cooling fluid (e.g., air, water, a polymeric cooling fluid, another type of coolant fluid) to flow across the exterior of the container 706. Convective cooling provided by the fluid current flowing across the container 706 can dramatically cool the interior of the container 706.

In some embodiments, before pelletization, the set of particles 705 can be tuned such that the produced pellets have a desired property, e.g., a property specified by a downstream user or determined according to an intended use of the produced pellets. For example, an additive can be added to the particulates. Merely by way of example, limestone can be ground and mixed with the set of particles 705. As another example, before being pelletized, the set of particles 705 can undergo one or more other pre-processing including, e.g., adjusting water content, milling, grinding, or the like, or a combination thereof.

The production system 700 may include a grinder 712 that is a destination of the container 706. The grinder 712 can be or otherwise include various types of grinders, such as a ball mill or a rod mill. Furthermore, some embodiments can obtain a target size distribution for a set of particles as a target parameter, and use a prediction model to predict a set of grinder operational parameters corresponding with the target size distribution before using the grinder 712. The grinder 712 can grind or mill the set of particles 705 before the set of particles 705 are pelletized. Furthermore, a mixture of the set of particles 705 and a second particulate material from a different source other than the heat processing of the input material 701 in the oven 704 can be ground or milled before being pelletized. As a further example, a second particulate material can be ground before being mixed with the set of particles 705 and pelletized. In some embodiments, particulate materials of a same source or different sources can have different dimensions. By grinding and/or milling, the particulate materials can have a suitable dimension for subsequent pelletization operations. For example, if a particulate material includes a waste material a portion of which has a dimension too large to be pelletized alone or with another particulate material (e.g., set of particles 705), the waste material can be ground or milled to reduce its dimension so that it is suitable for pelletization. As another example, a pellet product of the production system 700 can have different dimensions. The pellet product can go through a size selection to separate pellets of different dimensions; pellets whose dimensions do not satisfy a dimension specification (outside the range of desired dimensions) can be ground or milled and pelletized again alone or in combination with another particulate material (e.g., set of particles 705, a particulate material from a different source than the set of particles 705).

For simplicity, the following descriptions are provided with reference to set of particles 705, regardless of whether they are a mixture of particulate materials of different sources, or whether they are pre-processed and/or tuned. That is, the set of particles 705 can include particulates from the heat processing of an input material described elsewhere in the present disclosure alone, or in combination with another particulate material from a different source as described herein.

In some embodiments, the production system 700 includes a conveyor belt 716 and a hopper 714 that acts as destination of material being transported by the conveyor belt 716. In some embodiments, the conveyor belt 716 transports the set of particles 705 out of the oven 704. The production system 700 also includes a pelletization assembly 780 that serves as a destination for material being transported by the conveyor belt 716 and a hopper 714 that directs material from the conveyor belt 716 to the pelletization assembly 780. During operation of the production system 700, the grinder 712 outputs the set of particles 705 onto the conveyor belt 716, which may then convey the set of particles 705 to the hopper 714. Materials positioned into the set of particles 705 can then be processed by the pelletization assembly 780 to perform additional post-processing operations.

Some embodiments may use a set of models to determine one or more operational parameters for the pelletization assembly 780, where the set of models may include one or more analytical, semi-analytical, or empirical models. An operational parameter of the pelletization assembly 780 may include operational parameters of a dosing system 720, operational parameters of a mixing chamber 724, or operational parameters of a heat treatment system 728.

The pelletization assembly 780 includes the dosing system 720 to add materials to the set of particles 705, the mixing chamber 724 to mix the set of particles 705 with the additional materials that are added by the dosing system 720, and the heat treatment system 728 to receive mixed product provided by the mixing chamber 724. In some embodiments, the dosing system 720 can add one or more lower-volatility materials such as a calcium compound, an ash material, a slag material, or other materials to the set of particles 705, where the added material may be recycled from another operation. For example, some embodiments may use dosing system 720 to mix the set of particles 705 with ash material and/or slag material extracted from the oven 704.

In some embodiments, the dosing system 720 can be configured to add the set of particles 705 with at least one of an amount of water, an amount of acid, or a binder or a cross-linker with the use of the dosing system 720. Embodiments of the present technology can use the dosing system 720 to add a buffer solution, basic solution, acid solution, or other chemicals to the set of particles 705 to modify a surface pH of the set of particles 705 to meet a target pH. In some embodiments, the acids or other materials added to the set of particles 705 by the dosing system 720 can change a surface chemistry of the set of particles 705, such as by adding hydroxide groups (i.e., hydroxyl groups) or carboxylic acid groups (i.e., carboxyl groups) to the surfaces of the set of particles 705 or downstream products generated from the set of particles 705. For example, some embodiments may generate carboxylic acid groups on the surface of the set of particles 705 by exposing the set of particles 705 to hydrochloric acid. Furthermore, embodiments of the present technology can accelerate binding activity by using the dosing system 720 to add a hydrophobic catalyst. Furthermore, embodiments of the present technology can add a non-sulfonated soap, such as a fatty acid salt, to the set of particles 705 to reduce sulfur content or other contaminants from the set of particles 705. Alternatively, or additionally, various other compounds may be added by the dosing system 720 to the particulates, such as another amphoteric surfactant or a glycerol.

In some embodiments, the dosing system 720 can control the amount of one or more binders (“a binder”) exposed to the set of particles 705, where the binder can functionalize carbons of the set of particles 705. In some embodiments, the set of particles 705 can be bound by the binder. In some embodiments, the binding of the pelletization can occur at room temperature. The binder can be hydrophobic, hydrophilic, or amphoteric, and can include molasses, carboxymethyl guar, hydroxypropyl carboxymethyl guar, Acacia gum, Xanthan gum, starches, modified starches, sodium alginate, carboxymethyl cellulose, hydroxyethyl cellulose, and/or hydroxyethyl methyl cellulose (Tylose). Merely by way of example, the set of particles 705 can have a relatively high water content, e.g., 30%, 40%, or 50%, and the binder can be hydrophilic such that the binder becomes cross-linked and/or draws water content from the set of particles 705, thereby making the set of particles more hydrophobic and the binder less hydrophilic. In some embodiments, can be expelled by the binder. Advantageously, the process of reducing water content from the set of particles 705 can proceed at room temperature without an extra input of heat or other input to remove water content, thereby potentially saving significant expenses that would otherwise be spent drying the set of particles 705. Furthermore, the ratio of the mass of any binder being used to the mass of the set of particles 705 may be controlled to not exceed a certain amount. For example, some embodiments may control the amount of binder such that the mass ratio of the binder to the set of particles 705 used may be less than or equal to 20%. In some embodiments, the amount of the binder added is selected such that the pellets 790 comprise less than 15%, 10%, 5%, 3%, 2%, 1%, 0.5%, or 0.1% of the binder by weight.

In some embodiments, the dosing system 720 can be used to perform operations to combine the binder with the set of particles 705 for pellet production. The operations for pellet production can include receiving processed materials comprising coke having a Coke Reactivity Index (CRI) of at least 30%. Furthermore, some embodiments may receive coke selected for other properties, such as coke having a maximum Coke Strength After Reaction (CSR) (e.g., no more than 1%, no more than 2%, no more 5%, no more than 10%, or no more than 15%). For example, the set of particles 705 may have a CSR equal to 1.5% and a CRI equal to 50%. The CRI and CSR values described herein can correspond to materials having a size greater than or equal to a threshold size, whether subsequently crushed to smaller particle sizes or not. The threshold size can be about 10 mm, 13 mm, 15 mm, 17 mm, 19 mm, 21 mm, 23 mm, or other size. In some embodiments, the processed materials comprise input material (e.g., material including carbon and/or a non-metal) that has been processed in an oven. In some embodiments, the processed materials additionally or alternatively comprise coke breeze, char, charcoal fines, biochar, and/or biochar fines.

The operations to combine a binder with the set of particles 705 for pellet production can also include blending one or more additives with the processed materials to form a blend. In some embodiments, the one or more additives comprise at least one of (i) a binder comprising at least one of molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), or polyvinyl alcohol, or (ii) a cross-linker comprising at least one of limestone, calcium, aluminum, magnesium, sodium, iron, nickel, cobalt, molybdenum, platinum, palladium, cadmium, ammonia, zirconium, or potassium. In some embodiments, the one or more additives comprise a binder configured to switch from a first state to a second state upon being blended with at least some of the processed materials, wherein the binder is more hydrophobic and less hydrophilic in the second state than in the first state.

As described elsewhere in this disclosure, the operations to combine a binder with the set of particles 705 for pellet production can further include pelletizing, at a temperature of no more than 200° F. (e.g., room temperature), the blend to produce a population of pellets. In some embodiments, pelletizing comprises pelletizing the blend without applying thermal treatment to the blend. Furthermore, in some embodiments, the mixing and setting of a binder with particles used to make a pell (“binding”) of pelletization operations may occur at room temperature or other temperature less than 200° F., 150° F., or 100° F. In some embodiments, the binder is hydrophobic. In some embodiments, the binder is hydrophilic. Examples of suitable binders include polysaccharides, molasses, carboxymethyl guar, hydroxypropyl carboxymethyl guar, Acacia gum, Xanthan gum, starches, modified starches, sodium alginate, carboxymethyl cellulose, hydroxyethyl cellulose, hydroxyethyl methyl cellulose (Tylose), water-soluble synthetic polymers (e.g., polyvinyl alcohol (PVOH, PVA, or PVAI)). Merely by way of example, the particulates 230 may have a relatively high water content, e.g., 30%, 40%, or 50%, and the binder may be hydrophobic such that water content in the particulates 230 may be expelled by the binder. The process of reducing water content from (e.g., drying) the particulates 230 may proceed without an extra input of, e.g., heat, such as at room temperature or other temperature less than 200° F., 150° F., or 100° F.

In some embodiments, the binder is in a first state prior to being blended with the particulates 230 and/or processed materials. Upon being blended with the particulates 230 and/or at least some of the processed materials, the binder can be configured to switch from the first state to a second state. The binder can be more hydrophilic in the first state than in the second state such that the binder can bind to the particulates 230, which may have a relatively high water content as discussed above. The binder can be more hydrophobic in the second state than in the first state such that the binder can expel water content (e.g., dry) the particulates 230 and/or the processed materials without the use of thermal treatments, which can be costly.

Furthermore, while some embodiments may use one or more components the dosing system 720 to perform operations to combine a binder with the set of particles 705, other components (e.g., other components shown in the production system 700 or other components described in this disclosure) can be used to combine binders with pre-pellet materials used for pellet production.

In some embodiments, the dosing system 720 can add a cross-linker to the set of particles 705. For example, the dosing system 720 may inject or otherwise expose the set of particles 705 to a solution including a cross-linker to form a cross-linked mixture. In some embodiments, a suitable cross-linker can include a homobifunctional cross-linking reagent or a heterobifunctional cross-linking reagent. Various types of materials can be used, such as polysaccharides (e.g., chitosan), zirconium carbonate, sodium borate (borax), peptides, or other cross-linking agents. Furthermore, various types of functional groups may be part of a cross-linking agent, such as amines, carboxylic acids, sulfhydryls, and carbonyls. In some embodiments, the cross-linker may be activated by heat or by cooling after a heating stage. Alternatively, or additionally, the cross-linker may be activated by other stimuli. For example, a cross-linker may be a photoreactive cross-linker, such as a compound containing benzophenone, aryl azides, and diazirine. Alternatively, or additionally, a cross-linker may be triggered by exposure to one or more classes of stimuli such as mechanical energy input (e.g., soundwaves (e.g., ultrasound)), chemical energy input, radiation energy input, and/or the like. In some embodiments, the cross-linker may include limestone, calcium, aluminum, magnesium, sodium, iron, nickel, cobalt, molybdenum, platinum, palladium, cadmium, ammonia, zirconium, potassium, or a mixture thereof. Furthermore, as described elsewhere in this disclosure, some embodiments may expose a cross-linker to the set of particles 705 or a product generated with the set of particles 705 with other components of the production system 700. Additionally, while the dosing system 720 may add various materials to the set of particles 705, other components of the production system 700 may also be used to add such material to the set of particles 705. In some embodiments, the amount of the cross-linker added is selected such that the pellets 790 comprise less than 10%, 1%, 0.1%, 0.01%, 0.001%, 0.0001%, or 0.00001% of the cross-linker by weight.

In some embodiments, a mixing chamber 724 of the pelletization assembly 780 can mix the set of particles 705 with materials added by the dosing system 720. For example, the mixing chamber 724 can mix the set of particles 705 with at least one of the binder or a cross-linker added by the dosing system 720. The set of particles 705 (or other particulate materials to be pelletized) can have a suitable property to allow or facilitate the pelletization to proceed. Examples of such properties include surface chemistries, surface morphologies, pi-stacking sites, etc., of the set of particles 705 (or other particulate materials to be pelletized). Merely by way of example, such properties include surface areas, porosities, surface tensions, surface charges, or the like, or a combination thereof, of the set of particles 705 (or other particulate materials to be pelletized).

In some embodiments, a heat treatment system 728 of the pelletization assembly 780 can be used to heat the set of particles 705 to a target mixing temperature before, while, or after the set of particles 705 have been mixed by the mixing chamber 724. Furthermore, the mixing chamber 724 and the heat treatment system 728 may be integrated such that the set of particles 705 is concurrently heated to a target mixing temperature and mixed. Additionally, the heat treatment system 728 may include a micro-pellet formation system 729 to form a set of micro-pellets 730 from the set of particles 705 during or after the heat treatment system 728 heats the set of particles 705 to a mixing temperature. For example, the micro-pellet formation system 729 can rotate portions of the set of particles 705 to form the set of micro-pellets 730. The set of micro-pellets 730 can be transported to a hopper 742 via the conveyance system 740 and funneled into a pelletizer system 750. As described elsewhere in this disclosure, some embodiments can use the set of micro-pellets 730 to form a final pellet, disc, or other target shape. Furthermore, it should be understood that while some embodiments may form the set of micro-pellets 730, other embodiments may form other shaped pre-pellet mixtures that can be shaped into final pellet products.

The pelletizer system 750 can then be used to produce pellet products, such as the pellets 790. Various types of pelletizing mechanisms can be used. For example, the pelletizer system 750 can be a disc pelletizing system, where embodiments of the present technology can pelletize the set of micro-pellets 730 by feeding the set of micro-pellets 730 (or another shaped pre-pellet mixture) onto a rotating disc of the pelletizer system 750. As the disc rotates, the set of micro-pellets 730 can be lifted and dropped onto a stationary tray on the disc. The centrifugal force generated by the rotating disc can then compress the material into small, round pellets. Furthermore, it should be understood that the pelletizer system 750 may use or include a grinder to process input particles into a target size distribution, where the grinder may include various types of grinders (e.g., a ball mill grinder, a rod mill grinder, etc.). Some embodiments may further use a prediction model to determine operational parameters for a grinder based on a target size distribution.

It should be understood that other pellet-forming systems can be used in lieu of the pelletizer system 750. For example, embodiments of the present technology can directly use the output of the mixing chamber 724 in conjunction with a table feeder system. Some embodiments may transport a pre-pellet mixture into a table feeder, where the pre-pellet mixture may include micro-pellets produced by the micro-pellet formation system 729 or other material produced by the dosing system 720, the mixing chamber 724, or the heat treatment system 728. When using the table feeder, some embodiments can actuate a table feeder motor to direct the pre-pellet mixture through an extruder tube of the table feeder. In some embodiments, the table feeder may include a cutter having a set of blades that cut the material being extruded from the extruder tube at regular intervals. Some embodiments may then use the extruded briquettes as coke pellets or other pellet shapes. Some embodiments may allow the extruded portions to dry for use as briquettes. Alternatively, some embodiments may heat the set of extruded portions for use as briquettes.

The pellets from the pelletizer system 750 can be directed to a pellet drying system 754 of the production system 700. The pellet drying system 754 can be configured to dry the pellets received. For example, the pellet drying system 754 can allow the pellets to dry naturally in ambient conditions, provide heat to actively dry the pellets, and/or reduce the hydrophilicity of the pellets (e.g., to transition the pellets from hydrophilic to hydrophobic). In some embodiments, the pellet drying system 754 can dynamically switch between ambient drying, active drying (e.g., drying in an oven set at 250 degrees Fahrenheit or other temperature), and/or reducing hydrophilicity (e.g., adding a hydrophobic catalyst, agent, or other material) based on, for example, the size, the composition, the moisture content, and/or other characteristics of the pellets and/or operating costs (e.g., adding heat can be costly). The pellet drying system 754 can dry the pellets for a predetermined period of time, a period of time that depends on one or more characteristics of the pellets, until a certain condition is met (e.g., a reduction in pellet mass by a percentage threshold, addition of a specified amount of hydrophobic material), and/or the like. In some embodiments, the pellet drying system 754 is configured to dry the pellets such that a moisture content of the pellets is no more than 5%, 4%, 3%, 2%, 1%, 0.5%, or 0.1%. A low moisture content can facilitate storage and transportation of the pellets.

In some embodiments, the production system 700 includes a pellet treatment system 760 that is configured to receive pellets from the pelletizer system 750 and/or the pellet drying system 754. For example, some embodiments can transport the output pellets of the pellet drying system 754 to the pellet treatment system 760. As described elsewhere in this disclosure, some embodiments may use the pellet treatment system 760 to immerse or otherwise expose a pellet to a cross-linker. For example, some embodiments may immerse a pellet into a vat that contains a cross-linker. Furthermore, if a stimuli-triggered cross-linker was previously mixed into the pellets produced by the pelletizer system 750 (e.g., being mixed into the set of particles 705), some embodiments may use the pellet treatment system 760 to create the stimulus. For example, some embodiments may mix a photoreactive cross-linker with the set of particles 705 such that the set of micro-pellets 730 includes the photoreactive cross-linker. The pellet treatment system 760 may include an ultraviolet (UV) light emission system that exposes the photoreactive cross-linker to UV light, which then causes some or all of a pellet to undergo a cross-linking reaction and form a cross-linked mixture.

Furthermore, the pellet treatment system 760 can perform coating operations to protect the structural integrity of a pellet. For example, the pellet treatment system 760 can coat the population of pellets 790 with lime, dolomite, another calcium-containing material, another binder, other surface modifiers, etc. Alternatively, or additionally, some embodiments can coat a pellet with dust to reduce adhesive properties of a pellet surface. For example, some embodiments can coat a pellet with a carbon-containing dust to reduce the adhesiveness of the surface of the pellet. Alternatively, or additionally, some embodiments can coat the surface of a coke pellet with a hydrophobic material, such as a paraffin, a hydrophobic polymer, or another type of hydrophobic material.

Alternatively, or additionally, the pellet treatment system 760 may be used to expose a pellet to other chemical treatments, heat treatments, or other treatments that alter a material or chemical property of a pellet to satisfy a set of target parameters. For example, some embodiments may expose a pellet produced by the pelletizer system 750 to an acid that changes surface chemistry of a pellet in order for the surface chemistry of the pellet to satisfy a target surface chemistry. Some embodiments may determine one or more operational parameters of the pellet treatment system 760 or another component of the production system 700 to achieve the target surface chemistry. For example, some embodiments can determine a set of chemical treatment parameters based on the target surface chemistry. Furthermore, some embodiments may select a set of operational parameters that result in changes to a pellet pH or a pellet hydrophobicity. For example, some embodiments can cause a pH of a resulting pellet to be greater than 6.0, despite having been processed with a low-PH material, such as hydrochloric acid. Furthermore, some embodiments may modify the cylindrical body of a pellet to include at least one hydrophilic portion (e.g., by adding hydroxyl groups to the surface of the pellet).

In some embodiments, the pellet treatment system 760 can include additional mechanical systems to screen pellets to remove undersized or oversized pellets or physically alter the shape of a pellet to achieve a target pellet size for the pellet. For example, the pellet treatment system 760 can include differently sized holes, apertures, gaps, and/or mesh filters that will filter multiple pellets such that pellets in a target size range are collected and pellets outside of one or more size thresholds are discarded. In some embodiments, the pellet treatment system 760 can screen pellets based on the strength of the pellet. For example, the pellets can be screened to obtain pellets having a target strength of at least 1 pound-force (lbf), 5 lbf, 10 lbf, 15 lbf, 20 lbf, 25 lbf, 30 lbf, 35 lbf, or 40 lbf. The target strength can depend on, for example, the size of the pellets, the composition of the pellets, the binder used, and/or other factors. The pellet strength can be determined based on a crush test, a drop test, a hardness test, a compressive strength test, a tensile strength test, an abrasion resistance test, and/or the like.

Alternatively, the pellet treatment system 760 can include a grinding hopper and a grinder to modify the size of a pellet. Some embodiments may activate an electromotor of a grinder and transport a set of larger pellets into a grinder hopper of the grinder. The grinder may then grind the set of larger pellets with a roller of the grinder or another grinder component to reduce the set of larger pellets into a set of smaller pellets that satisfy the target pellet size. Furthermore, some embodiments may obtain a set of target parameter values, such as a target pellet size for a coke pellet. Some embodiments may then use an analytical, empirical, or simulation model to determine a set of grinding parameters predicted to result in the target pellet size. Some embodiments may then control grinder operations based on the set of grinding parameters to generate the population of pellets 790.

In some embodiments, the output rate of the pelletization assembly 780 can be at least 1 ton per hour, 2 tons per hour, 3 tons per hour, 5 tons per hour, 6 tons per hour, 8 tons per hour, 10 tons per hour, 12 tons per hour, 15 tons per hours, 16 tons per hour, 18 tons per hour, or 20 tons per hour. In some embodiments, the pelletization assembly 780 can have a modular configuration in which one or more pelletization units can be used without all of the pelletization units being used.

In some embodiments, the pelletization assembly 780 can be set up in a vicinity of the oven 704. For instance, the pelletization assembly 780 can be set up in a plant where the oven 704 is located. In some embodiments, the pelletization assembly 780 can be set up as a portable facility so that it can be transported to where particulate materials, e.g., set of particles 705, one or more other particulate materials, are available for pelletization. In some embodiments, the pelletization assembly 780 can have a modular configuration such that a certain number of pelletization units can be assembled at a location. In some embodiments, the number of pelletization units of the pelletization assembly 780 can be adjusted depending on the processing needs at that location, or a change thereof, from time to time.

It is understood that the description of the production system 700 is provided for illustration purposes and is not intended to be limiting. In some embodiments, the production system 700 can omit the oven 704 and include the pelletization assembly 780. The pelletization assembly 780 can pelletize a particulate material from a single source, or a mixture of particulate materials from multiple sources. For example, the pelletization assembly 780 can pelletize one or more particulate materials including at least one of charcoal fines, coal fines, petroleum coke breeze, coke breeze, iron fines, other metal fines, blast furnace dust, baghouse fines, waste materials, petroleum coke breeze, anthracite fines, calcined anthracite fines, iron ore pellet fines, DRI pellet fines, DRI/HBI pellet fines, or the like, QPD, spilled coal and coke recovery materials, coal wash plant refuse material, or a combination thereof. Merely by way of example, the pelletization assembly 780 can pelletize blast furnace dust that includes blast furnace iron fines.

### VI. Pellet and Pellet Production

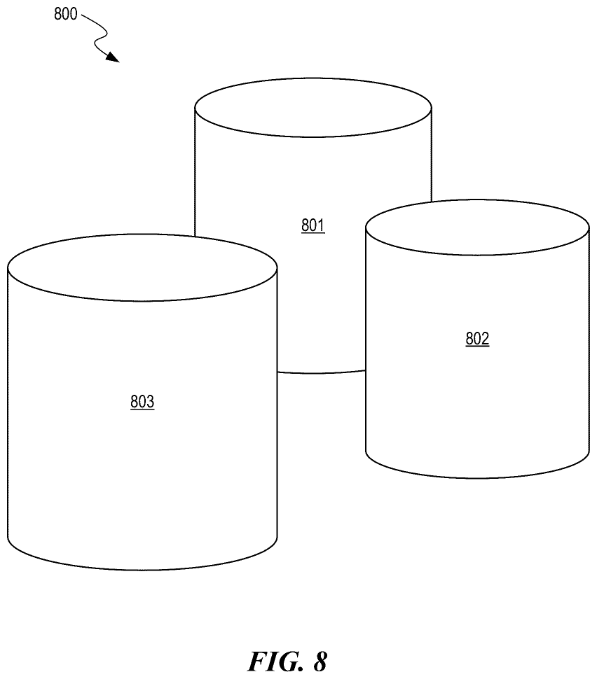

FIG. 8 depicts pellets in accordance with embodiments of the present technology. Embodiments of the present technology can produce a population of pellets, such as the population of pellets 790, using operations described in this disclosure, where the population of pellets includes a set of pellets 800. The set of pellets 800 can include a first pellet 801, second pellet 802, and third pellet 803. In some embodiments, the set of pellets 800 can include at least one of calcium, aluminum, magnesium, sodium, iron, nickel, cobalt, molybdenum, platinum, palladium, cadmium, ammonia, zirconium, potassium, or a mixture thereof. In some embodiments, the set of pellets 800 of the population of pellets can include an oxide. In some embodiments, the set of pellets 800 of the population of pellets can include at least one of iron-containing pellets, nitrogen-containing pellets, carbon-containing pellets, etc. Examples of carbon-containing pellets include coke pellets, char pellets, biochar pellets, petroleum coke pellets, anthracite pellets, calcined anthracite pellets, etc. In some embodiments, individual pellets of the population of pellets can include at least one of coke breeze, coal fines, charcoal fines, biochar fines, blast furnace dust, baghouse fines, petroleum coke, anthracite, calcined anthracite, QPD, spilled coal and coke recovery materials, coal wash plant refuse material, or waste materials. In some embodiments, individual pellets can include a component of interest including, e.g., carbon, nitrogen, oxygen, an alkali metal, aluminum, iron, or a transition metal. For instance, the component of interest of one or more pellets of the set of pellets 800 can be at least 30%, 40%, 50%, 60%, 70%, 80%, or 90% of the set of pellets 800 by weight.

In some embodiments, one or more pellets of the set of pellets 800 can have a dimension suitable for their intended use. In some embodiments, individual pellets can have a diameter of at least 1/25 in., 1/23 in., 1/20 in., 1/16 in., 1/10 in., ⅛ in., ⅕ in., ¼ in., ⅓ in., ½ in., ¾ in., 1 in., or in a range from 1/25 inches to 1.5 inches, in a range from ⅕ inches to 1.5 inches, in a range from ¼ inches to 1 inch, or in a range from ½ inches to 1 inch. For example, iron-containing pellets can be further processed to produce steel in, e.g., an EAF; such iron-containing pellets can have a diameter of ¼ inches to 1 inch, or ½ inches to 1 inch. As another example, pellets so produced can be used as fuel for a specific type of burner, an animal feed, a fertilizer, a cleaning agent configured to filter air, water, etc., and therefore has a suitable property profile including, e.g., dimension, density, surface area, porosity, and composition, or the like, or a combination thereof.

In some embodiments, the density of one or more pellets of the set of pellets 800 can be different from the density of oven-produced particulates, such the set of particles 705. For example, the density of the first pellet 801 can be higher than the density of the set of particles 705.

In some embodiments, the one or more pellets of the set of pellets 800 include a density of at least 1 gram per cubic centimeter (g/cm³), 1.2 g/cm³, 1.4 g/cm³, 1.6 g/cm³, 1.8 g/cm³, or 2 g/cm³, or in a range from 1.2 g/cm³ to 2.5 g/cm³, or in a range from 1.5 g/cm³ to 1.8 g/cm³.

In some embodiments, the one or more pellets of the set of pellets 800 include a strength of at least 1 lbf, 5 lbf, 10 lbf, 20 lbf, 30 lbf, 40 lbf, 50 lbf, 60 lbf, 70 lbf, 80 lbf, 90 lbf, 100 lbf, 120 lbf, or in a range from 10 lbf to 120 lbf, a range from 10 lbf to 100 lbf, a range from 20 lbf to 90 lbf, or a range from 40 lbf to 80 lbf.

In some embodiments, the one or more pellets of the set of pellets 800 include a total ash content between 1-20%, between 3-15%, or between 5-10%. In some embodiments, the one or more pellets of the set of pellets 800 include a sulfur content less than 10%, 5%, 3%, 2%, 1%, 0.5%, or 0.1%.

In some embodiments, the one or more pellets of the set of pellets 800 have a friability such that, when broken apart, the pellets produce a negligible amount of dust. For example, when broken apart, the pellets can produce less than 10%, 5%, 3%, 2%, or 1% airborne particles (e.g., dust) by weight. In another example, when broken apart, each pellet can produce pieces that (i) each comprise at least 5%, 10%, 15%, or 20% of the starting weight of the pellet, and/or (ii) together comprise at least 50%, 60%, 70%, 80%, or 90% of the starting weight of the pellet.

In some embodiments, the set of pellets 800 includes carbon-containing pellets. The set of pellets 800 can include a heat of combustion of at least 150 kilojoules per mole (KJ/mol), 180 KJ/mol, 200 kJ/mol, 220 KJ/mol, 250 kJ/mol, or 260 kJ/mol, 280 kJ/mol, 300 KJ/mol, 320 KJ/mol, in a range from 150 KJ/mol to 350 KJ/mol, in a range from 180 KJ/mol to 350 KJ/mol, or in a range from 200 KJ/mol to 350 KJ/mol. In some embodiments, the set of pellets 800 includes a water content of below 1%, 2%, 3%, 4%, 5%, 6%, 8%, 10%, 12%, 15%, in a range from 2% to 12%, in a range from 4% to 10%, or in a range from 5% to 10%. In some embodiments, the set of pellets 800 includes a sulfur content of below 0.2%, 0.5%, 0.6%, 0.8%, 1%, 1.5%, 1.8%, 2%, 2.5%, 2.8%, 3%, 3.5%, 4%, in a range from 0.1% to 1%, in a range from 0.2% to 1%, in a range from 0.4% to 1%, or in a range from 0.5% to 1%, 0.1% to 1.5%, in a range from 0.2% to 1.5%, in a range from 0.4% to 1.5%, or in a range from 0.5% to 1.5%, 0.1% to 2%, in a range from 0.2% to 2%, in a range from 0.4% to 2%, or in a range from 0.5% to 2%, 1% to 1.5%, in a range from 1% to 2%, in a range from 1% to 2.5%, or in a range from 1% to 3%. In some embodiments, the set of pellets 800 includes a chelation agent. In some embodiments, one or more pellets of the set of pellets 800 have a shape of a cylinder, a sphere, and/or an ovoid. In some embodiments, one or more pellets of the set of pellets 800 have a predetermined degradation profile. For instance, the first pellet 801 can have a predetermined degradation profile that the individual pellets break into chunks.

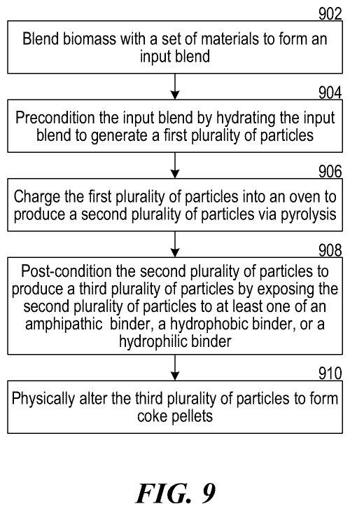

FIG. 9 is a flowchart illustrating a method 900 for forming coke pellets in accordance with embodiments of the present technology. While the steps of the method 900 are described below in a particular order, one or more of the steps can be performed in a different order or omitted, and the method 900 can include additional and/or alternative steps. Additionally, although the method 900 may be described below with reference to the embodiments of the present technology described herein, the method 900 can be performed with other embodiments of the present technology.

The method 900 begins at block 902 by blending biomass with a set of materials to form an input blend. The biomass can have a first volatility and the set of materials can have a second volatility lower than the first volatility. The biomass can be formed by heating organic material in a low-oxygen environment and/or can be formed from a variety of feedstocks, including agricultural waste, wood chips, natural rubber, and other biomass materials. The biomass can include biochar. The set of materials can include at least one of charcoal fines, coal fines, crushed foundry coke breeze, petroleum coke breeze, coke breeze, or other materials with lower volatility than the biomass.

At block 904, the method 900 continues by preconditioning the input blend by hydrating the input blend to generate a first plurality of particles. In some embodiments, preconditioning the input blend includes hydrating the input blend based on a moisture parameter and a mass of the input blend to generate the first plurality of particles.

At block 906, the method 900 continues by charging the first plurality of particles into an oven to produce a second plurality of particles via pyrolysis. In some embodiments, charging includes activating a conveyor to move a tray supporting the particles beneath a hammer, stamping the input blend (or particles) using the hammer, and charging the input blend (or particles) into the oven after stamping the input blend (or particles).

At block 908, the method 900 continues by post-conditioning the second plurality of particles to produce a third plurality of particles by exposing the second plurality of particles to at least one of an amphipathic binder, a hydrophobic binder, or a hydrophilic binder. In some embodiments, post-conditioning includes (i) exposing the second plurality of particles to an acid, wherein exposing the second plurality of particles to the acid comprises adding water, and the acid to the second plurality of particles in a mixing chamber to generate a pre-pellet mixture, (ii) heating the mixing chamber to a mixing temperature, (iii) mechanically mixing the pre-pellet mixture while the pre-pellet mixture is at the mixing temperature, (iv) shaping the pre-pellet mixture to form a shaped pre-pellet mixture by rotating the pre-pellet mixture, and (v) adding a cross-linker to the shaped pre-pellet mixture to form the third plurality of particles, wherein the third plurality of particles comprises a cross-linked mixture.

At block 910, the method 900 continues by physically altering the third plurality of particles to form coke pellets. In some embodiments, physically altering includes actuating a cutter to divide the cross-linked mixture to form the coke pellets.

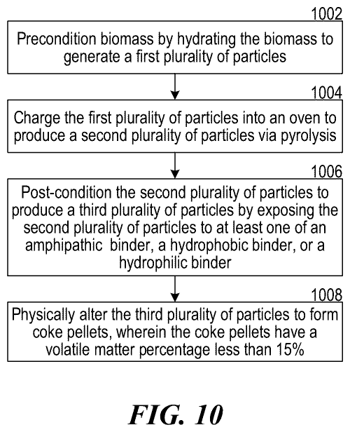

FIG. 10 is a flowchart illustrating another method 1000 for forming coke pellets in accordance with embodiments of the present technology. While the steps of the method 1000 are described below in a particular order, one or more of the steps can be performed in a different order or omitted, and the method 1000 can include additional and/or alternative steps. Additionally, although the method 1000 may be described below with reference to the embodiments of the present technology described herein, the method 1000 can be performed with other embodiments of the present technology.

The method 1000 begins at block 1002 by preconditioning biomass by hydrating the biomass to generate a first plurality of particles. The biomass can be formed by heating organic material in a low-oxygen environment and/or can be formed from a variety of feedstocks, including agricultural waste, wood chips, natural rubber, and other biomass materials. The biomass can include biochar. In some embodiments, preconditioning the biomass includes hydrating the biomass based on a moisture parameter and a mass of the biomass to generate the first plurality of particles.

At block 1004, the method 1000 continues by charging the first plurality of particles into an oven to produce a second plurality of particles via pyrolysis. In some embodiments, charging includes activating a conveyor to move a tray supporting the particles beneath a hammer, stamping the particles using the hammer, and charging the particles into the oven after stamping the particles.

At block 1006, the method 1000 continues by post-conditioning the second plurality of particles to produce a third plurality of particles by exposing the second plurality of particles to at least one of an amphipathic binder, a hydrophobic binder, or a hydrophilic binder. In some embodiments, post-conditioning includes (i) exposing the second plurality of particles to an acid, wherein exposing the second plurality of particles to the acid comprises adding water, and the acid to the second plurality of particles in a mixing chamber to generate a pre-pellet mixture, (ii) heating the mixing chamber to a mixing temperature, (iii) mechanically mixing the pre-pellet mixture while the pre-pellet mixture is at the mixing temperature, (iv) shaping the pre-pellet mixture to form a shaped pre-pellet mixture by rotating the pre-pellet mixture, and (v) adding a cross-linker to the shaped pre-pellet mixture to form the third plurality of particles, wherein the third plurality of particles comprises a cross-linked mixture.

At block 1008, the method 1000 continues by physically altering the third plurality of particles to form coke pellets, wherein the coke pellets have a volatile matter percentage less than 15%. In some embodiments, physically altering includes actuating a cutter to divide the cross-linked mixture to form the coke pellets.

### VII. Conclusion

It should be understood that some embodiments can perform one or more of the operations described for a method without another of the operations described for the method or another method. For example, some embodiments can modify an input material's moisture content using operations described by process portion 508 without performing one or more operations described by process portion 510. Furthermore, although the technology has been described in language that is specific to certain structures, materials, and methodological steps, it is to be understood that the invention defined in the appended claims is not necessarily limited to the specific structures, materials, and/or steps described. Rather, the specific aspects and steps are described as forms of implementing the claimed invention. Further, certain aspects of the new technology described in the context of particular embodiments can be combined or eliminated in other embodiments. Moreover, while advantages associated with certain embodiments of the technology have been described in the context of those embodiments, other embodiments can also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims. Unless otherwise indicated, all numbers or expressions, such as those expressing dimensions, physical characteristics, etc., used in the specification (other than the claims) are understood as modified in all instances by the term “approximately.” At the very least, and not as an attempt to limit the application of the doctrine of equivalents to the claims, each numerical parameter recited in the specification or claims that is modified by the term “approximately” should at least be construed in light of the number of recited significant digits and by applying ordinary rounding techniques. Moreover, all ranges disclosed herein are to be understood to encompass and provide support for claims that recite any and all subranges or any and all individual values subsumed therein. For example, a stated range of 1 to 10 should be considered to include and provide support for claims that recite any and all subranges or individual values that are between and/or inclusive of the minimum value of 1 and the maximum value of 10; that is, all subranges beginning with a minimum value of 1 or more and ending with a maximum value of 10 or less (e.g., 5.5 to 10, 2.34 to 3.56, and so forth) or any values from 1 to 10 (e.g., 3, 5.8, 9.9994, and so forth). Furthermore, unless otherwise indicated, the phrases “based on” and “based at least in part on” are interchangeably used in this disclosure. For example, the function “f(x,y)” can be described as being based on the variable “x” or being based at least in part on “x.”

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.
A.1. A method for forming coke pellets, the method comprising:
   blending biomass with a set of materials to form an input blend, wherein the biomass has a first volatility and the set of materials has a second volatility lower than the first volatility;
   preconditioning the input blend by hydrating the input blend to generate a first plurality of particles;
   charging the first plurality of particles into an oven to produce a second plurality of particles via pyrolysis;
   post-conditioning the second plurality of particles to produce a third plurality of particles by exposing the second plurality of particles to at least one of an amphipathic binder, a hydrophobic binder, or a hydrophilic binder; and
   physically altering the third plurality of particles to form coke pellets.
A.2. The method of embodiment A.1, comprising:
   obtaining a biomass volatile matter (VM) amount and a biomass VM release rate parameter of the biomass;
   obtaining a second VM amount and second VM release rate parameter assigned to the set of materials;
   obtaining a target VM amount associated with a target pellet of the coke pellets;
   determining a set of oven parameters based at least in part on the target VM amount; and
   determining a material ratio indicating a ratio of an amount of the set of materials to an amount of the biomass based at least in part on the biomass VM amount, the biomass VM release rate parameter, the second VM amount, the second VM release rate parameter, and the set of oven parameters, wherein blending the biomass with the set of materials comprises blending the biomass with the set of materials based at least in part on the material ratio.
A.3. The method of embodiment A.2, wherein determining the material ratio comprises:
   obtaining a target ash fusion temperature;
   obtaining a biomass ash fusion temperature; and
   obtaining a second ash fusion temperature of the set of materials, wherein determining the material ratio comprises:
      predicting a candidate ash fusion temperature using an ash fusion prediction model based at least in part on the biomass ash fusion temperature, the second ash fusion temperature, and a candidate ratio as inputs; and
      wherein the candidate ratio matches the material ratio.
A.4. The method of embodiment A.2, wherein determining the material ratio comprises:
   obtaining a target reactivity index;
   obtaining a biomass reactivity index; and
   obtaining a second reactivity index of the set of materials, wherein determining the material ratio comprises:
      predicting a candidate reactivity index using a reactivity index prediction model based at least in part on the biomass reactivity index, the second reactivity index, and a candidate ratio as inputs; and
      wherein the candidate ratio matches the material ratio.
A.5. The method of embodiment A.2, wherein the set of materials is retrieved from the oven.
A.6. The method of embodiment A.5, wherein the set of materials comprises a coke oven at least one of coke breeze, high sulfur petroleum coke, anode waste, spent activated carbon, or quench pond dipping.
A.7. The method of embodiment A.2, wherein the set of materials comprises a polymeric material.
A.8. The method of embodiment A.7, wherein the polymeric material comprises pitch or rubber.
A.9. The method of embodiment A.2, wherein the set of materials comprises a mineral.
A.10. The method of embodiment A.9, wherein the mineral comprises calcium oxides or hydroxides.
A.11. The method of embodiment A.1, wherein preconditioning the input blend comprises hydrating the input blend based on a moisture parameter and a mass of the input blend to generate the first plurality of particles.
A.12. The method of embodiment A.11, further comprising:
   determining a target particle size associated with at least one of the second plurality of particles and the third plurality of particles;
   obtaining a set of oven parameters; and
   determining the moisture parameter based at least in part on the set of oven parameters and the target particle size by using a particle size model.
A.13. The method of embodiment A.11, wherein:
   hydrating the input blend comprises:
      dispensing the input blend from a hopper storing the input blend onto a tray via a hopper port; and
      concurrently rotating the input blend and hydrating the input blend via a nozzle directed toward the tray by activating a rotary actuator; and
   charging the input blend into the oven comprises:
      activating a conveyor to move the tray beneath a hammer;
      stamping the input blend using the hammer; and
      charging the input blend into the oven after stamping the input blend.
A.14. The method of embodiment A.11, wherein hydrating the input blend comprises activating a nozzle to spray water on the input blend while rotating the input blend.
A.15. The method of embodiment A.11, further comprising mechanically mixing the input blend after hydrating the input blend.
A.16. The method of embodiment A.11, further comprising mechanically grinding the input blend to satisfy a target distribution of input blend particle sizes.
A.17. The method of embodiment A.11, further comprising stamp charging the input blend after hydrating the input blend.
A.18. The method of embodiment A.1, further comprising configuring the oven based on a set of oven parameters, wherein a first parameter of the set of oven parameters indicates a target temperature that is greater than 1,000° F. for a first duration, wherein charging the first plurality of particles into the oven comprises heating an interior of the oven to at least the target temperature for the first duration to convert the first plurality of particles into the second plurality of particles.
A.19. The method of embodiment A.18, wherein the set of oven parameters indicates at least one of a second duration at a temperature different from the target temperature, a draft control parameter, or a heat exchanger flow rate.
A.20. The method of embodiment A.18, further comprising angling an uptake port to increase an airflow through the oven.
A.21. The method of embodiment A.18, further comprising:
   obtaining a set of target pellet parameters; and
   determining the set of oven parameters based at least in part on the set of target pellet parameters.
A.22. The method of embodiment A.21, wherein the set of target pellet parameters comprises at least one of a pellet density, a pellet pore size, or a pellet geometry.
A.23. The method of embodiment A.1, wherein post-conditioning the second plurality of particles comprises:
   exposing the second plurality of particles to an acid, wherein exposing the second plurality of particles to the acid comprises adding water, and the acid to the second plurality of particles in a mixing chamber to generate a pre-pellet mixture;
   heating the mixing chamber to a mixing temperature;
   mechanically mixing the pre-pellet mixture while the pre-pellet mixture is at the mixing temperature;
   shaping the pre-pellet mixture to form a shaped pre-pellet mixture by rotating the pre-pellet mixture;
   adding a cross-linker to the shaped pre-pellet mixture to form the third plurality of particles, wherein the third plurality of particles comprises a cross-linked mixture; and
   wherein physically altering the third plurality of particles comprises actuating a cutter to divide the cross-linked mixture to form the coke pellets.
A.24. The method of embodiment A.23, further comprising transporting the second plurality of particles into a mixing chamber via a flat push hot car (FPHC).
A.25. The method of embodiment A.24, further comprising:
   covering a top of the FPHC to enclose the second plurality of particles;
   spraying an exterior of the FPHC with a fluid using a nozzle to cool the second plurality of particles; and
   concurrently with the spraying of the exterior of the FPHC, rotating at least one of the FPHC or the nozzle with respect to a center of the FPHC.
A.26. The method of embodiment A.24, further comprising:
   covering a top of the FPHC to enclose the second plurality of particles;
   transporting the FPHC through a tubular interior against a fluid current flowing through the tubular interior; and
   spraying a fluid through the tubular interior while the FPHC is being transported through the tubular interior, wherein the fluid cools the FPHC.
A.27. The method of embodiment A.23, further comprising:
   obtaining a set of target pellet parameters indicating at least one of a target pellet moisture, a target pellet strength, and a target pellet density, a target pellet size, a target pellet sulfur content, or a target pellet ash fusion temperature; and
   determining operational parameters for an amount of the binder, an amount of the acid, or an amount of the cross-linker to use by providing the set of target pellet parameters to a prediction model, wherein producing the pre-pellet mixture comprises producing the pre-pellet mixture based at least in part on the operational parameters.
A.28. The method of embodiment A.26, further comprising:
   cooling the coke pellets after the heating of the mixing chamber; and
   coating the coke pellets with at least one of a calcium-containing material, a binder material, or a surface modifying agent when a temperature of the coke pellets is less than the mixing temperature.
A.29. The method of embodiment A.23, further comprising coating the coke pellets with a carbon-containing dust.
A.30. The method of embodiment A.23, wherein rotating the pre-pellet mixture comprises rotating the pre-pellet mixture in a second direction to form a set of micro-pellets, wherein each respective micro-pellet is smaller than the coke pellets.
A.31. The method of embodiment A.23, further comprising:
   transporting the pre-pellet mixture into a table feeder;
   actuating a motor of the table feeder to direct the pre-pellet mixture through an extruder tube;
   cutting extruded portions of the pre-pellet mixture to form a set of extruded briquettes, wherein adding the cross-linker to the pre-pellet mixture comprises exposing the cross-linker to the set of extruded briquettes; and
   heating the set of extruded briquettes to form the coke pellets.
A.32. The method of embodiment A.23, wherein physically altering the third plurality of particles comprises:
   forming a set of intermediate pellets from the cross-linked mixture;
   transporting the set of intermediate pellets to a grinding hopper of a grinder; and
   powering an electromotor of the grinder to grind the set of intermediate pellets with a roller of the grinder to reduce the set of intermediate pellets to a target pellet size of the coke pellets.
A.33. The method of embodiment A.23, wherein producing the pre-pellet mixture comprises adding a calcium compound to the pre-pellet mixture.
A.34. The method of embodiment A.23, wherein producing the pre-pellet mixture comprises adding an ash material or slag material to the pre-pellet mixture.
A.35. The method of embodiment A.23, wherein producing the pre-pellet mixture comprises exposing the coke pellets to a buffer solution to modify the surface chemistry of the coke pellets to a target pH.
A.36. The method of embodiment A.23, wherein a ratio of a mass of the binder to a mass of the second plurality of particles is less than 20%.
A.37. The method of embodiment A.23, further comprising:
   obtaining a set of target parameters indicating a target surface chemistry; and
   determining a set of chemical treatment parameters based at least in part on the target surface chemistry, wherein adding the water, the binder, and the acid comprises adding the acid based at least in part on the set of chemical treatment parameters.
A.38. The method of embodiment A.23, further comprising:
   obtaining target parameter data indicating a target pellet size;
   selecting a set of grinding parameters based at least in part on the target parameter data; and
   grinding the second plurality of particles based at least in part on the set of grinding parameters.
A.39. The method of embodiment A.23, further comprising screening the second plurality of particles with a mesh filter to remove particles that do not satisfy a size threshold.
A.40. The method of embodiment A.23, further comprising adding a fatty acid salt to the second plurality of particles.
A.41. The method of embodiment A.23, further comprising adding glycerol to the second plurality of particles.
A.42. The method of embodiment A.23, further comprising adding an amphoteric surfactant to the second plurality of particles.
A.43. The method of embodiment A.23, wherein adding the acid adds a hydroxyl group and a carboxyl group to the second plurality of particles.
A.44. The method of embodiment A.23, further comprising increasing a hydrophobicity of a surface of the coke pellets by exposing the coke pellets to a paraffin, a hydrophobic coating, or a polymer.
A.45. The method of embodiment A.1, wherein the coke pellets comprise a first coke pellet, wherein:
   the first coke pellet is shaped as a cylindrical body;
   the cylindrical body comprises pyrolyzed biomass and a binder material;
   a pH of a water content of the first coke pellet is greater than 6.0; and
   a surface of the cylindrical body comprises a hydrophilic portion.
A.46. The method of embodiment A.1, further comprising exposing the second plurality of particles to an acid.
A.47. The method of embodiment A.1, wherein the coke pellets comprise a first coke pellet that is hydrophobic.
A.48. The method of embodiment A.1, wherein exposing the second plurality of particles to the binder causes at least one of the second plurality of particles, the third plurality of particles, or the coke pellets to expel water.
B.1. A method comprising:
   blending biomass with a set of materials to form an input blend, wherein the biomass has a first volatility and the set of materials has a second volatility lower than the first volatility; and
   conditioning the input blend by hydrating the input blend to generate a first plurality of particles.
B.2. The method of embodiment B.1, further comprising:
   obtaining a biomass volatile matter (VM) amount and a biomass VM release rate parameter of the biomass;
   obtaining a second VM amount and second VM release rate parameter assigned to the set of materials;
   obtaining a target VM amount associated with a target pellet of coke pellets;
   determining a set of oven parameters based at least in part on the target VM amount; and
   determining a material ratio indicating a ratio of an amount of the set of materials to an amount of the biomass based at least in part on the biomass VM amount, the biomass VM release rate parameter, the second VM amount, the second VM release rate parameter, and the set of oven parameters, wherein blending the biomass with the set of materials comprises blending the biomass with the set of materials based at least in part on the material ratio.
B.3. The method of embodiment B.2, wherein determining the material ratio comprises:
   obtaining a target ash fusion temperature;
   obtaining a biomass ash fusion temperature; and
   obtaining a second ash fusion temperature of the set of materials, wherein determining the material ratio comprises:
      predicting a candidate ash fusion temperature using an ash fusion prediction model based at least in part on the biomass ash fusion temperature, the second ash fusion temperature, and a candidate ratio as inputs; and
      wherein the candidate ratio matches the material ratio.
B.4. The method of embodiment B.2, wherein determining the material ratio comprises:
   obtaining a target reactivity index;
   obtaining a biomass reactivity index; and
   obtaining a second reactivity index of the set of materials, wherein determining the material ratio comprises:
      predicting a candidate reactivity index using a reactivity index prediction model based at least in part on the biomass reactivity index, the second reactivity index, and a candidate ratio as inputs; and
      wherein the candidate ratio matches the material ratio.
B.5. The method of embodiment B.2, further comprising charging the first plurality of particles into an oven to produce a second plurality of particles via pyrolysis, wherein the set of materials is retrieved from the oven.
B.6. The method of embodiment B.5, wherein the set of materials comprises at least one of coke breeze, high sulfur petroleum coke, anode waste, spent activated carbon, or quench pond dipping.
B.7. The method of embodiment B.2, wherein the set of materials comprises a polymeric material.
B.8. The method of embodiment B.7, wherein the polymeric material comprises pitch or rubber.
B.9. The method of embodiment B.2, wherein the set of materials comprises a mineral.
B.10. The method of embodiment B.9, wherein the mineral comprises calcium oxides or hydroxides.
B.11. The method of embodiment B.1, wherein preconditioning the input blend comprises hydrating the input blend based on a moisture parameter and a mass of the input blend to generate the first plurality of particles.
B.12. The method of embodiment B.11, further comprising:
   determining a target particle size associated with at least one of the second plurality of particles and the third plurality of particles;
   obtaining a set of oven parameters; and
   determining the moisture parameter based at least in part on the set of oven parameters and the target particle size by using a particle size model.
B.13. The method of embodiment B.11, wherein:
   hydrating the input blend comprises:
      dispensing the input blend from a hopper storing the input blend onto a tray via a hopper port; and
      concurrently rotating the input blend and hydrating the input blend via a nozzle directed toward the tray by activating a rotary actuator; and
   charging the input blend into the oven comprises:
      activating a conveyor to move the tray beneath a hammer;
      stamping the input blend using the hammer; and
      charging the input blend into the oven after stamping the input blend.
B.14. The method of embodiment B.11, wherein hydrating the input blend comprises activating a nozzle to spray water on the input blend while rotating the input blend.
B.15. The method of embodiment B.11, further comprising mechanically mixing the input blend after hydrating the input blend.
B.16. The method of embodiment B.11, further comprising stamp charging the input blend after hydrating the input blend.
B.17. The method of embodiment B.1, further comprising mechanically grinding the input blend to satisfy a target distribution of input blend particle sizes.
B.18. The method of embodiment B.17, wherein the grinder is at least one of a ball mill grinder or a rod mill grinder.
B.19. The method of embodiment B.17, further comprising determining a set of grinder operational parameters to satisfy a target particle size distribution.
B.20. The method of embodiment B.1, further comprising configuring the oven based on a set of oven parameters, wherein a first parameter of the set of oven parameters indicates a target temperature that is greater than 1,000° F. for a first duration, wherein charging the first plurality of particles into the oven comprises heating an interior of the oven to at least the target temperature for the first duration to convert the first plurality of particles into the second plurality of particles.
B.21. The method of embodiment B.20, wherein the set of oven parameters indicates at least one of a second duration at a temperature different from the target temperature, a draft control parameter, or a heat exchanger flow rate.
B.22. The method of embodiment B.20, further comprising angling an uptake port to increase an airflow through the oven.
B.23. The method of embodiment B.20, further comprising:
   obtaining a set of target pellet parameters; and
   determining the set of oven parameters based at least in part on the set of target pellet parameters.
B.24. The method of embodiment B.23, wherein the set of target pellet parameters comprises at least one of a pellet density, a pellet pore size, or a pellet geometry.
B.25. The method of embodiment B.1, further comprising: (i) charging the first plurality of particles into an oven to produce a second plurality of particles via pyrolysis, and (ii) cooling the second plurality of particles after the second plurality of particles is removed from the oven.
C.1. A method comprising:
   conditioning a first plurality of particles to produce a second plurality of particles by
   exposing the first plurality of particles to a binder, wherein the binder is at least one of a hydrophilic binder, hydrophobic binder, or amphipathic binder; and
   physically altering the second plurality of particles to form coke pellets.
C.2. The method of embodiment C.1, wherein the first plurality of particles comprises a carbonaceous species.
C.3. The method of embodiment C.1, wherein the first plurality of particles comprises coke.
C.4. The method of embodiment C.1, wherein the coke pellets are hydrophobic.
C.5. The method of embodiment C.1, wherein exposing the first plurality of particles to the binder causes at least one of the first plurality of particles, the second plurality of particles, or the coke pellets to expel water.
C.6. The method of embodiment C.1, further comprising exposing the first plurality of particles to an acid.
C.7. The method of embodiment C.1, wherein post-conditioning the first plurality of particles comprises:
   transporting the first plurality of particles into a mixing chamber via a conveyor vessel;
   exposing the first plurality of particles to an acid, wherein exposing the first plurality of particles to the acid comprises adding water, a binder, and the acid to the first plurality of particles in the mixing chamber to generate a pre-pellet mixture;
   heating the mixing chamber to a mixing temperature;
   mechanically mixing the pre-pellet mixture while the pre-pellet mixture is at the mixing temperature;
   shaping the pre-pellet mixture to form a shaped pre-pellet mixture by rotating the pre-pellet mixture;
   adding a cross-linker to the shaped pre-pellet mixture to form the second plurality of particles, wherein the second plurality of particles comprises a cross-linked mixture; and
   wherein physically altering the second plurality of particles comprises actuating a cutter to divide the cross-linked mixture to form the coke pellets.
C.8. The method of embodiment C.7, further comprising:
   covering a top of the conveyor vessel to enclose the first plurality of particles;
   spraying an exterior of the conveyor vessel with a fluid using a nozzle to cool the first plurality of particles; and
   concurrently with the spraying of the exterior of the conveyor vessel, rotating at least one of the conveyor vessel or the nozzle with respect to a center of the conveyor vessel.
C.9. The method of embodiment C.7, further comprising:
   covering a top of the conveyor vessel to enclose the first plurality of particles;
   transporting the conveyor vessel through a tubular interior against a fluid current flowing through the tubular interior; and
   spraying a fluid through the tubular interior while the conveyor vessel is being transported through the tubular interior, wherein the fluid cools the conveyor vessel.
C.10. The method of embodiment C.7, further comprising:
   obtaining a set of target pellet parameters indicating at least one of a target pellet moisture, a target pellet strength, and a target pellet density, a target pellet size, a target pellet sulfur content, or a target pellet ash fusion temperature; and
   determining operational parameters for an amount of the binder, an amount of the acid, or an amount of the cross-linker to use by providing the set of target pellet parameters to a prediction model, wherein producing the pre-pellet mixture comprises producing the pre-pellet mixture based at least in part on the operational parameters.
C.11. The method of embodiment C.8, further comprising:
   cooling the coke pellets after the heating of the mixing chamber; and
   coating the coke pellets with at least one of a calcium-containing material, a binder material, or a surface modifying agent when a temperature of the coke pellets is less than the mixing temperature.
C.12. The method of embodiment C.7, further comprising coating the coke pellets with a carbon-containing dust.
C.13. The method of embodiment C.7, wherein rotating the pre-pellet mixture comprises rotating the pre-pellet mixture in a second direction to form a set of micro-pellets, wherein each respective micro-pellet is smaller than the coke pellets.
C.14. The method of embodiment C.7, further comprising:
   transporting the pre-pellet mixture into a table feeder;
   actuating a motor of the table feeder to direct the pre-pellet mixture through an extruder tube;
   cutting extruded portions of the pre-pellet mixture to form a set of extruded briquettes, wherein adding the cross-linker to the pre-pellet mixture comprises exposing the cross-linker to the set of extruded briquettes; and
   heating the set of extruded briquettes to form the coke pellets.
C.15. The method of embodiment C.7, wherein physically altering the second plurality of particles comprises:
   forming a set of intermediate pellets from the cross-linked mixture;
   transporting the set of intermediate pellets to a grinding hopper of a grinder; and
   powering an electromotor of the grinder to grind the set of intermediate pellets with a roller of the grinder to reduce the set of intermediate pellets to a target pellet size of the coke pellets.
C.16. The method of embodiment C.7, wherein producing the pre-pellet mixture comprises adding a calcium compound the pre-pellet mixture.
C.17. The method of embodiment C.7, wherein producing the pre-pellet mixture comprises adding an ash material or slag material to the pre-pellet mixture.
C.18. The method of embodiment C.7, wherein producing the pre-pellet mixture comprises exposing the coke pellets to a buffer solution to modify the surface chemistry of the coke pellets to a target pH.
C.19. The method of embodiment C.7, wherein a ratio of a mass of the binder to a mass of the first plurality of particles is less than 20%.
C.20. The method of embodiment C.7, further comprising:
   obtaining a set of target parameters indicating a target surface chemistry; and
   determining a set of chemical treatment parameters based at least in part on the target surface chemistry, wherein adding the water, the binder, and the acid comprises adding the acid based at least in part on the set of chemical treatment parameters.
C.21. The method of embodiment C.7, further comprising:
   obtaining target parameter data indicating a target pellet size;
   selecting a set of grinding parameters based at least in part on the target parameter data; and
   grinding the first plurality of particles based at least in part on the set of grinding parameters.
C.22. The method of embodiment C.7, further comprising screening the first plurality of particles with a mesh filter to remove particles that do not satisfy a size threshold.
C.23. The method of embodiment C.7, further comprising adding a fatty acid salt to the first plurality of particles.
C.24. The method of embodiment C.7, further comprising adding glycerol to the first plurality of particles.
C.25. The method of embodiment C.7, further comprising adding an amphoteric surfactant to the first plurality of particles.
C.26. The method of embodiment C.7, wherein adding the acid adds a hydroxyl group and a carboxyl group to the first plurality of particles.
C.27. The method of embodiment C.7, further comprising increasing a hydrophobicity of a surface of the coke pellets by exposing the coke pellets to a paraffin, a hydrophobic coating, or a polymer.
C.28. The method of embodiment C.1, wherein the coke pellets comprise a first coke pellet, wherein:
   the first coke pellet is shaped as a cylindrical body;
   the cylindrical body comprises pyrolyzed biomass and a binder material;
   a pH of the first coke pellet is greater than 6.0; and
   a surface of the cylindrical body comprises a hydrophilic portion.
D.1 A pellet production system, comprising:
   a pelletization assembly including:
      a dosing system configured to add one or more materials to a set of biomass particles,
      a mixer configured to mix the one or more materials with the set of biomass particles,
      a heat treatment system configured to heat the set of biomass particles, wherein the heat treatment system includes a micro-pellet formation system configured to form a set of micro-pellets from the set of biomass particles and the one or more materials, and
      a pelletizer system positioned downstream of the heat treatment system and configured to produce pellet products from the set of micro-pellets.
D.2 The system of embodiment D.1, wherein the set of biomass particles have a first volatility and the one or more materials have a second volatility lower than the first volatility.
D.3 The system of embodiment D.1, wherein the one or more materials include at least one of water, a binder, a cross-linker, a buffer solution, an acid solution, or a basic solution.
D.4 The system of embodiment D.1, wherein the heat treatment system is configured to heat the set of biomass particles while the mixer mixes the one or more materials with the set of biomass particles.
D.5 The system of embodiment D.1, wherein the micro-pellet formation system is configured to rotate portions of the set of biomass particles to form the set of micro-pellets.
D.6 The system of embodiment D.1, wherein the pelletizer system includes a disc pelletizing system.
D.7 The system of embodiment D.1, wherein the pelletization assembly further comprises:
   a hopper positioned upstream of the pelletizer system; and
   a conveyance system configured to transport the set of micro-pellets from the heat treatment system to the hopper.
D.8 The system of embodiment D.1, wherein the pelletization assembly further comprises a drying system positioned downstream of the pelletizer system and configured to dry the pellet products.
D.9 The system of embodiment D.1, wherein the pelletization assembly further comprises a pellet treatment system positioned downstream of the pelletizer system and configured to expose the pellet products to at least one of a chemical treatment, a heat treatment, or a screening mechanism.
D.10 The system of embodiment D.1, further comprising:
   an oven configured to process input materials to form the set of biomass particles; and
   a grinder positioned downstream of the oven and upstream of the pelletization assembly, and configured to grind or mill the set of biomass particles.
E.1 A composition, comprising:
   a plurality of coke pellets, wherein the coke pellets comprise (i) biomass having a first volatile matter percentage, (ii) a set of materials having a second volatile matter percentage lower than the first volatile matter percentage, and (iii) a binder,
   wherein the coke pellets have a third volatile matter percentage less than 15%.
E.2 The composition of claim E.1, wherein the third volatile matter percentage is less than 6%.
E.3 The composition of claim E.1, wherein the third volatile matter percentage is less than 3%.
E.4 The composition of claim E.1, wherein the first volatile matter percentage is between 10-90%, and wherein the second volatile matter percentage is between 0-15%.
E.5 The composition of claim E.1, wherein the first volatile matter percentage is between 20-80%, and wherein the second volatile matter percentage is between 1-10%.
E.6 The composition of claim E.1, wherein the coke pellets have a friability such that, when broken apart, each coke pellet produces a plurality of pieces that (i) each comprise at least 5%, 10%, 15%, or 20% of a starting weight of the coke pellet, and (ii) together comprise at least 50%, 60%, 70%, 80%, or 90% of the starting weight of the coke pellet.
E.7 The composition of claim E.1, wherein the coke pellets have a friability such that, when broken apart, the coke pellets produce a negligible amount of dust.
E.8 The composition of claim E.1, wherein the coke pellets, when broken apart, produce less than 1% airborne particles by weight.
E.9 The composition of claim E.1, wherein the coke pellets have a moisture content of less than 3%.
E.10 The composition of claim E.1, wherein the coke pellets have a strength of at least 10 lbf, 20 lbf, 30 lbf, or 40 lbf.
E.11 The composition of claim E.1, wherein the coke pellets have a density of at least 1.1 g/cm³, 1.3 g/cm³, 1.5 g/cm³, 1.8 g/cm³, or 2.1 g/cm³.
E.12 The composition of claim E.1, wherein the coke pellets have a total ash content between 1-20%, between 3-15%, or between 5-10%.
E.13 The composition of claim E.1, wherein the coke pellets have a sulfur content less than 10%, 5%, 3%, 2%, 1%, 0.5%, or 0.1%.
F.1 A method for forming coke pellets, the method comprising:
   hydrating biomass to generate a first plurality of particles;
   charging the first plurality of particles into an oven to produce a second plurality of particles via pyrolysis;
   exposing the second plurality of particles to at least one of an amphipathic binder, a hydrophobic binder, or a hydrophilic binder to produce a third plurality of particles; and
   physically altering the third plurality of particles to form coke pellets, wherein the coke pellets have a volatile matter percentage less than 15%.
F.2 The method of claim F.1, wherein the method does not include blending the biomass with a set of materials having a lower volatility than the biomass.
F.3 The method of claim F.1, wherein the biomass has a second volatile matter percentage less than 15%.
F.4 The method of claim F.1, wherein the third volatile matter percentage is less than 6%.
F.5 The method of claim F.1, further comprising adding a hydrophobic material to the first, second, or third plurality of particles.

What is claimed is:

1. A composition, comprising:
a plurality of coke pellets, wherein the coke pellets comprise (i) biomass having a first volatile matter percentage, (ii) a set of materials having a second volatile matter percentage lower than the first volatile matter percentage, and (iii) a binder,
wherein the coke pellets have a third volatile matter percentage less than 15%.

2. The composition of claim 1, wherein the third volatile matter percentage is less than 6%.

3. The composition of claim 1, wherein the first volatile matter percentage is between 20-80%, and wherein the second volatile matter percentage is between 1-10%.

4. The composition of claim 1, wherein the coke pellets have a friability such that, when broken apart, each coke pellet produces a plurality of pieces that (i) each comprise at least 10% of a starting weight of the coke pellet, and (ii) together comprise at least 50% of the starting weight of the coke pellet.

5. The composition of claim 1, wherein the coke pellets, when broken apart, produce less than 1% airborne particles by weight.

6. The composition of claim 1, wherein the coke pellets have a moisture content of less than 3%.

7. The composition of claim 1, wherein the coke pellets have a strength of at least 10 lbf.

8. The composition of claim 1, wherein the coke pellets have a density of at least 1.5 g/cm³.

9. The composition of claim 1, wherein the coke pellets have a total ash content between 3-15%.

10. The composition of claim 1, wherein the coke pellets have a sulfur content less than 1%.

11. A method for forming coke pellets, the method comprising:
hydrating biomass to generate a first plurality of particles;
charging the first plurality of particles into an oven to produce a second plurality of particles via pyrolysis;
exposing the second plurality of particles to at least one of an amphipathic binder, a hydrophobic binder, or a hydrophilic binder to produce a third plurality of particles; and
physically altering the third plurality of particles to form coke pellets, wherein the coke pellets have a volatile matter percentage less than 15%.

12. The method of claim 11, wherein the method does not include blending the biomass with a set of materials having a lower volatility than the biomass.

13. The method of claim 11, wherein the biomass has a second volatile matter percentage less than 15%.

14. The method of claim 11, wherein the third volatile matter percentage is less than 6%.

15. The method of claim 11, further comprising adding a hydrophobic material to the first, second, or third plurality of particles.

16. A method for forming coke pellets, the method comprising:
blending biomass with a set of materials to form an input blend, wherein the biomass has a first volatility and the set of materials has a second volatility lower than the first volatility;
preconditioning the input blend by hydrating the input blend to generate a first plurality of particles;
charging the first plurality of particles into an oven to produce a second plurality of particles via pyrolysis;
post-conditioning the second plurality of particles to produce a third plurality of particles by exposing the second plurality of particles to at least one of an amphipathic binder, a hydrophobic binder, or a hydrophilic binder; and
physically altering the third plurality of particles to form coke pellets.

17. The method of claim 16, further comprising:
obtaining a biomass volatile matter (VM) amount and a biomass VM release rate parameter of the biomass;
obtaining a second VM amount and second VM release rate parameter assigned to the set of materials;
obtaining a target VM amount associated with a target pellet of the coke pellets;
determining a set of oven parameters based at least in part on the target VM amount; and
determining a material ratio indicating a ratio of an amount of the set of materials to an amount of the biomass based at least in part on the biomass VM amount, the biomass VM release rate parameter, the second VM amount, the second VM release rate parameter, and the set of oven parameters, wherein blending the biomass with the set of materials comprises blending the biomass with the set of materials based at least in part on the material ratio.

18. The method of claim 17, wherein determining the material ratio comprises:
obtaining a target ash fusion temperature;
obtaining a biomass ash fusion temperature; and
obtaining a second ash fusion temperature of the set of materials,
wherein determining the material ratio comprises predicting a candidate ash fusion temperature using an ash fusion prediction model based at least in part on the biomass ash fusion temperature, the second ash fusion temperature, and a candidate ratio as inputs, and
wherein the candidate ratio matches the material ratio.

19. The method of claim 17, wherein determining the material ratio comprises:
obtaining a target reactivity index;
obtaining a biomass reactivity index; and
obtaining a second reactivity index of the set of materials, wherein determining the material ratio comprises:
predicting a candidate reactivity index using a reactivity index prediction model based at least in part on the biomass reactivity index, the second reactivity index, and a candidate ratio as inputs; and
wherein the candidate ratio matches the material ratio.

20. The method of claim 16, wherein preconditioning the input blend comprises hydrating the input blend based on a moisture parameter and a mass of the input blend to generate the first plurality of particles.

21. The method of claim 20, further comprising:
determining a target particle size associated with at least one of the second plurality of particles and the third plurality of particles;
obtaining a set of oven parameters; and
determining the moisture parameter based at least in part on the set of oven parameters and the target particle size by using a particle size model.

22. The method of claim 20, wherein:
hydrating the input blend comprises:
dispensing the input blend from a hopper storing the input blend onto a tray via a hopper port; and
concurrently rotating the input blend and hydrating the input blend via a nozzle directed toward the tray by activating a rotary actuator; and
charging the input blend into the oven comprises:
activating a conveyor to move the tray beneath a hammer;
stamping the input blend using the hammer; and
charging the input blend into the oven after stamping the input blend.

23. The method of claim 16, further comprising configuring the oven based on a set of oven parameters, wherein a first parameter of the set of oven parameters indicates a target temperature that is greater than 1,000° F. for a first duration, wherein charging the first plurality of particles into the oven comprises heating an interior of the oven to at least the target temperature for the first duration to convert the first plurality of particles into the second plurality of particles.

24. The method of claim 23, wherein the set of oven parameters indicates at least one of a second duration at a temperature different from the target temperature, a draft control parameter, or a heat exchanger flow rate.

25. The method of claim 23, further comprising angling an uptake port to increase an airflow through the oven.

26. The method of claim 16, wherein post-conditioning the second plurality of particles comprises:
exposing the second plurality of particles to an acid, wherein exposing the second plurality of particles to the acid comprises adding water, and the acid to the second plurality of particles in a mixing chamber to generate a pre-pellet mixture;
heating the mixing chamber to a mixing temperature;
mechanically mixing the pre-pellet mixture while the pre-pellet mixture is at the mixing temperature;
shaping the pre-pellet mixture to form a shaped pre-pellet mixture by rotating the pre-pellet mixture; and
adding a cross-linker to the shaped pre-pellet mixture to form the third plurality of particles, wherein the third plurality of particles comprises a cross-linked mixture,
wherein physically altering the third plurality of particles comprises actuating a cutter to divide the cross-linked mixture to form the coke pellets.

27. The method of claim 16, wherein:
the coke pellets comprise a first coke pellet,
the first coke pellet is shaped as a cylindrical body,
the cylindrical body comprises pyrolyzed biomass and a binder material,
a pH of a water content of the first coke pellet is greater than 6.0, and
a surface of the cylindrical body comprises a hydrophilic portion.

28. The method of claim 16, further comprising exposing the second plurality of particles to an acid.

29. The method of claim 16, wherein the coke pellets comprise a first coke pellet that is hydrophobic.

30. The method of claim 16, wherein exposing the second plurality of particles to the binder causes at least one of the second plurality of particles, the third plurality of particles, or the coke pellets to expel water.
